(19) United States
(12) Patent Application Publication
(10) Pub. No.: US 2004/0161234 A1
(43) Pub. Date: Aug. 19, 2004

(54) Apparatus, method and program for controlling optical power

(75) Inventor: Kimio Ozawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/774,844

(22) Filed: Feb. 10, 2004

(30) Foreign Application Priority Data
Feb. 10, 2003 (JP) 032517/2003

(51) Int. Cl. H04B 10/08

(52) U.S. Cl. 398/33

(57) ABSTRACT

An optical power control apparatus, an optical power control method and an optical power control program for reducing the effect of coherent crosstalk noise in between optical signals having the same wavelength when at least multiplexing optical signals of respective channels. In an optical intermediate node with a level equalizer, a pre-amplifier amplifies a WDM (Wavelength Division Multiplexing) optical signal. Subsequently, a first arrayed waveguide grating included in a level equalizer demultiplexes the WDM optical signal into optical signals corresponding to respective channels. The demultiplexed optical signals each having passed through an attenuator of each channel are multiplexed by a second arrayed waveguide grating. An OSC termination section feeds an apparatus controller with channel alive information indicating the presence or absence of an optical signal with respect to each channel. Based on the channel alive information, the insertion loss at an attenuator corresponding to the channel where no optical signal has been transmitted is increased to maximum so that the multiplexing of an optical signal which has leaked into the channel is reduced. Besides, failures in attenuators can be detected making use of photodiodes.

### FIELD OF THE INVENTION

The present invention relates to an optical power control apparatus, an optical power control method and an optical power control program for adjusting the level of optical signals with different wavelengths multiplexed by a optical wavelength multiplexer at an optical intermediate node or the like, and more particularly, to an optical power control apparatus, an optical power control method and an optical power control program for adjusting the level of optical signals to multiplex the signals after once demultiplexing an optical signal into the optical signals having different wavelengths.

### BACKGROUND OF THE INVENTION

In the optical intermediate node of a optical transport system which multiplexes a plurality of optical signals to transmit them, a received optical signal is demultiplexed into optical signals having different wavelengths, and the levels of the respective optical signals with different wavelengths are adjusted before multiplexing. After that, the multiplexed signal is sent to a transmission line. When multiplexing optical signals, an optical power control apparatus such as a level equalizer is used for equalizing the optical power levels of respective wavelengths or channels to be multiplexed.

There has been disclosed an example of such optical power control apparatus in Japanese Patent Application laid open No. HEI11-331093. FIG. 1 is a block diagram schematically showing the configuration of the conventional optical power control apparatus. Referring to FIG. 1, the optical power control apparatus 100 comprises a first arrayed waveguide grating (AWG) 111, attenuators (ATT) 113₁ to 113ₙ, a control circuit 114, optical splitters 115₁ to 115ₙ, photodiodes (PD) 116₁ to 116ₙ, and a second arrayed waveguide grating 118.

The first arrayed waveguide grating 111 demultiplexes a WDM (Wavelength Division Multiplexing) optical signal 101, which has been amplified by an amplifier (not shown), into optical signals 112₁ to 112ₙ having different wavelengths. Channels CH-1 to CH-n are allocates for the optical signals 112₁ to 112ₙ. The demultiplexed optical signals 112₁ to 112ₙ of the channels CH-1 to CH-n are input to the attenuators 113₁ to 113ₙ, respectively. The attenuators 113₁ to 113ₙ attenuate the levels of the optical signals 112₁ to 112ₙ, respectively, to a desired value by adjusting the insertion loss. The control circuit 114 controls the attenuation.

The optical splitters 115₁ to 115ₙ are set on the output side of the attenuators 113₁ to 113ₙ. The optical splitters 115₁ to 115ₙ split the demultiplexed optical signals 112₁ to 112ₙ, respectively. Each of the optical splitters 115₁ to 115ₙ leads one output therefrom to the corresponding photodiode (116₁ to 116ₙ) to detect the power level of the optical signal which has passed through the attenuator (113₁ to 113ₙ). The detection results are input to the control circuit 114. Thereby, feedback control is performed so that the optical signals 112₁ to 112ₙ, which have passed through the attenuators 113₁ to 113ₙ, are maintained at desired levels, respectively. The other output from the respective optical splitters 115₁ to 115ₙ is input to the second arrayed waveguide grating 118. The second arrayed waveguide grating 118 multiplexes the optical signals 112₁ to 112ₙ. Thus, the optical power control apparatus 100 outputs a WDM optical signal 119 which has been adjusted to the desired level with respect to each wavelength.

In the conventional optical power control apparatus 100, however, when the first arrayed waveguide grating 111 demultiplexes a WDM optical signal, it occurs that an optical signal in one channel (wave length) leaks into another channel and the second arrayed waveguide grating 118 multiplexes the same optical signal again by the channel. There is no problem if the optical signal is multiplexed in precisely the same state as the optical signal in its proper waveguide. In practice, however, a slight delay, etc. occurs when the optical signal passes through a waveguide other than its proper waveguide. This causes so-called coherent crosstalk noise when the second arrayed waveguide grating 118 multiplexes the same optical signals.

Besides, when an optical signal leaks into a channel where no other optical signal is present, a proper optical signal for the channel is not input to the attenuator (113₁ to 113ₙ), and therefore, the signal level input to the attenuator is low. On this account, the attenuator does not actively attenuate the input signal. Consequently, the optical signal which has leaked into a channel where no other optical signal is present is at a higher signal level than that of an optical signal which has leaked into a channel where another optical signal is present when multiplexed by the second arrayed waveguide grating 118. Accordingly, the effect of coherent crosstalk noise especially increases when the second arrayed waveguide grating 118 multiplexes such optical signal and the original signal.

### SUMMARY OF THE INVENTION

It is therefore an object of the present invention to provide an optical power control apparatus, an optical power control method and an optical power control program for reducing the effect of coherent crosstalk noise in between optical signals having the same wavelength when at least multiplexing optical signals of respective channels.

In accordance with the present invention, there is provided an optical power control apparatus comprising: a multiplexer for multiplexing two or more optical signals having different wavelengths; an optical signal transmitting section including a plurality of channels for transmitting optical signals each having a different wavelength, respectively, to the multiplexer, which allows at least part of each optical signal to leak into a channel for an optical signal having another wavelength in at least part of the channels; an optical signal transmission detector for detecting the presence or absence of optical signals transmitted through their respective proper channels (channels originally allocated for the respective signals); and switches or signal level adjusting sections set in the channels of the optical signal transmitting section, respectively, for shutting down or increasing the insertion loss in the channel where no optical signal transmission has been detected by the optical signal transmission detector.

That is, according to the present invention, in the case where the optical power control apparatus is provided with the optical signal transmitting section in which at least a part of an optical signal with a certain wavelength leaks into a channel for another wavelength in at least part of the channels to the multiplexer, the optical signal transmission detector detects the presence of proper optical signals (optical signals transmitted through the channels originally allocated for them, respectively). Based on the detection result, the switch or signal level adjusting section of each channel shuts down or increases the insertion loss in the channel when no optical signal transmission has been detected by the optical signal transmission detector. Thereby, it is possible to prevent the effect of coherent crosstalk noise.

In accordance with the present invention, there is provided an optical power control apparatus comprising: a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels; demultiplexed signal level detectors set in the channels, respectively, for detecting the power levels of the optical signals; an optical signal detector for deciding whether or not the power level of each optical signal detected by the demultiplexed signal level detector set in each channel is lower than the lowest level of an received optical signal to detect optical signal input with respect to each channel; switches or signal level adjusting sections set in the channels, respectively, for stopping the input optical signals or adjusting the levels of the optical signals of the respective channels demultiplexed by the demultiplexer; a multiplexer for multiplexing the optical signals of the respective channels, which have passed through the switches or the signal level adjusting sections; and a controller which controls the respective switches or signal level adjusting sections so as to shut down or attenuate the level of the optical signal of the channel where no optical signal input has been detected by the optical signal detector to the greatest extent possible.

That is, according to the present invention, after the demultiplexer has demultiplexed a multiplexed optical signal obtained by multiplexing optical signals with different wavelengths each corresponding to one channel, the demultiplexed signal level detectors detects the power levels of the optical signals of the respective channels. Then, the optical signal detector determines whether or not the power level of each optical signal is lower than the lowest received signal level to detect optical signal input with respect to each channel. Besides, switches or signal level adjusting sections are set preliminary to the multiplexing of the optical signals by the multiplexer for shutting down or attenuating the level of the optical signal of the channel where no proper optical signal is being transmitted under the control of the controller. Consequently, a leakage signal in the channel is not to be multiplexed by the multiplexer or attenuated to the greatest extent possible. Thereby, it is possible to prevent or reduce the effect of coherent crosstalk noise.

### BRIEF DESCRIPTION OF THE DRAWINGS

The objects and features of the present invention will become more apparent from the consideration of the following detailed description taken in conjunction with the accompanying drawings in which:

FIG. 1 is a block diagram schematically showing the configuration of a conventional optical power control apparatus;

FIG. 2 is a block diagram showing the substantial part of an optical intermediate node provided with a level equalizer according to the first embodiment of the present invention;

FIG. 3 is a flowchart showing the operation of an apparatus controller depicted in FIG. 2 for shutdown control according to the first embodiment of the present invention;

FIG. 4 is a flowchart showing the operation of the apparatus controller depicted in FIG. 2 for detecting failures in attenuators according to the first embodiment of the present invention;

FIG. 5 is a block diagram showing the substantial part of an optical intermediate node provided with a level equalizer using an optical power control apparatus according to the second embodiment of the present invention;

FIG. 6 is a block diagram showing a level equalizer ATT controller and a circuit part related thereto according to the second embodiment of the present invention;

FIG. 7 is a state transition diagram showing the operation of the level equalizer ATT controller according to the second embodiment of the present invention;

FIG. 8 is a block diagram showing the substantial part of an optical intermediate node provided with a level equalizer using an optical power control apparatus according to the third embodiment of the present invention;

FIG. 9 is a diagram showing the principle of reductions in crosstalk produced in arrayed waveguide gratings according to the embodiments of the present invention; and

FIG. 10 is a diagram showing the principle of reductions in crosstalk produced in arrayed waveguide gratings according to the modified form of the embodiments of the present invention.

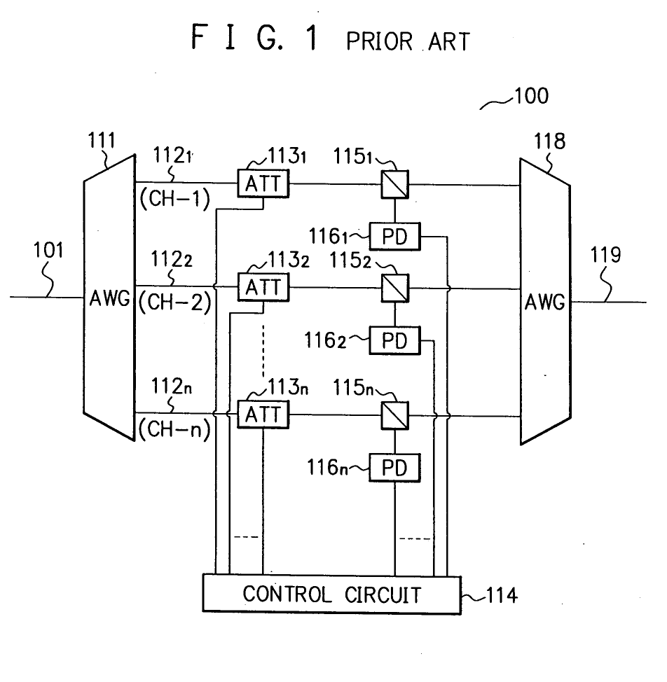

### DESCRIPTION OF THE PREFERRED EMBODIMENTS

Referring now to the drawings, a description of preferred embodiments of the present invention will be given in detail.

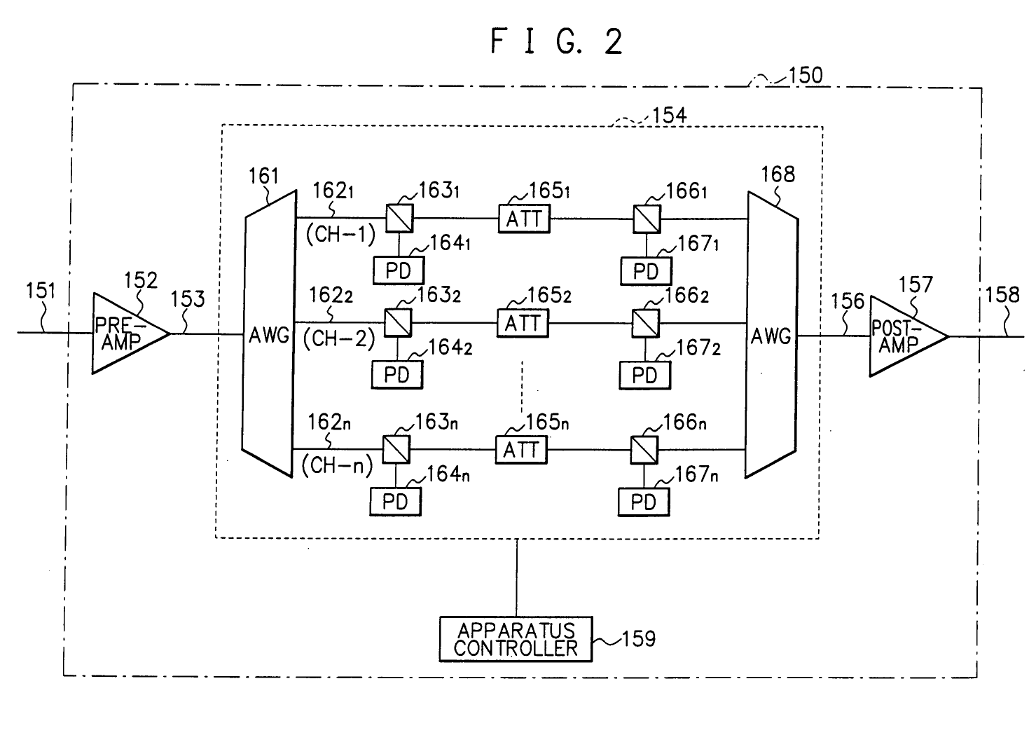

FIG. 2 is a block diagram showing the substantial part of an optical intermediate node provided with a level equalizer according to the first embodiment of the present invention. Referring to FIG. 2, the optical intermediate node with a level equalizer 150 comprises a pre-amplifier 152, a level equalizer 154, a post-amplifier 157, and an apparatus controller 159.

When a WDM (Wavelength Division Multiplexing) optical signal 151, which is composed of optical signals each having a different wavelength, is input to the pre-amplifier 152, the pre-amplifier 152 amplifies the WDM optical signal 151 to compensate losses which occurred when the WDM optical signal 151 was transmitted via a transmission line (not shown). The WDM optical signal 153 output from the pre-amplifier 152 is input to the level equalizer 154. The level equalizer 154 equalizes the power levels of the optical signals (the WDM optical signal 153) with respect to each wavelength. After the optical power levels of respective wavelengths are equalized by the level equalizer 154, the WDM optical signal 156 output from the level equalizer 154 is input to the post-amplifier 157. The post-amplifier 157 amplifies the WDM optical signal 156, and outputs the WDM optical signal 158. The apparatus controller 159 handles a variety of managements in the optical intermediate node with a level equalizer 150. Thus, the WDM optical signal 158 is transmitted from the optical intermediate node with a level equalizer 150 to an external transmission line (not shown).

The level equalizer 154 includes a first arrayed waveguide grating (AWG) 161, first optical splitters 163₁ to 163ₙ, first photodiodes (PD) 164₁ to 164ₙ, attenuators (ATT) 165₁ to 165ₙ, second optical splitters 166₁ to 166ₙ, second photodiodes (PD) 167₁ to 167ₙ, and a second arrayed waveguide grating 168.

When the WDM optical signal 153 output from the pre-amplifier 152 is input to the first arrayed waveguide grating 161, the first arrayed waveguide grating 161 demultiplexes the WDM optical signal 153 into optical signals 162₁ to 162ₙ having different wavelengths. Channels CH-1 to CH-n are allocated for the optical signals 162₁ to 162ₙ, respectively. The demultiplexed optical signals 162₁ to 162ₙ of the channels CH-1 to CH-n are input to the first optical splitters 163₁ to 163ₙ, respectively. The first optical splitters 163₁ to 163ₙ split the demultiplexed optical signals 162₁ to 162ₙ, respectively. One output from the first optical splitter (163₁ to 163ₙ) is input to the corresponding first photodiode (164₁ to 164ₙ). The first photodiode 164₁ to 164ₙ detect the power levels of the optical signals which have been demultiplexed by the first arrayed waveguide grating 161. The detection results are input to the apparatus controller 159. The apparatus controller 159 compares the signal levels with a prescribed threshold value with respect to each channel. When there is a channel in which the signal level is equal to or lower than the threshold value, the apparatus controller 159 determines that a proper optical signal (an optical signal for which the channel is originally allocated) is not present in the channel. On the other hand, as to a channel in which the signal level higher than the threshold value has been detected, the apparatus controller 159 determines that a proper optical signal is present in the channel.

The other output from the first optical splitter (163₁ to 163ₙ) is input to the corresponding attenuator (165₁ to 165ₙ). The attenuators 165₁ to 165ₙ attenuate the levels of the optical signals 162₁ to 162ₙ, respectively, to a desired value by adjusting the insertion loss. The amount of attenuation is continuously variable, ranging from the case where an optical signal is hardly attenuated to the case where an optical signal is substantially shut off. Various types of such attenuators (165₁ to 165ₙ) have been produced on a commercial basis as, for example, variable attenuators. The variable attenuator is capable of attenuating an input optical signal by 20 dB or more.

The second optical splitters 166₁ to 166ₙ are set on the output side of the attenuators 165₁ to 165ₙ. The second optical splitters 166₁ to 166ₙ split the input optical signals 162₁ to 162ₙ, respectively. One output from the second optical splitter (166₁ to 166ₙ) is input to the corresponding second photodiode (167₁ to 167ₙ). The second photodiode 167₁ to 167ₙ detect the power levels of the optical signals which have passed through the attenuators 165₁ to 165n. The detection results are input to the apparatus controller 159. Thereby, feedback control is applied to the insertion loss caused by the attenuators 165₁ to 165n. The other output from the respective second optical splitters 166₁ to 166ₙ is input to the second arrayed waveguide grating 168. The second arrayed waveguide grating 168 multiplexes the optical signals 162₁ to 162ₙ each having a different wavelength. The WDM optical signal 156 output from the second arrayed waveguide grating 168 is amplified by the post-amplifier 157 as described previously. After that, the WDM optical signal 158 output from the post-amplifier 157 is transmitted from the optical intermediate node with a level equalizer 150 to the outside.

In the optical intermediate node with a level equalizer 150 according to the first embodiment of the present invention, the apparatus controller 159 determines that no proper optical signal is present in a channel when the optical power level of the channel detected by the first photodiode (164₁ to 164ₙ) is lower than the level anticipated when an optical signal has been transmitted to the channel. Consequently, the apparatus controller 159 increases the insertion loss caused by the attenuator (165₁ to 165ₙ) to maximum. For example, if the first photodiode 164ₙ has detected an optical power level equal to or lower than a prescribed reference level (no-signal criterion level) L₁ in the channel CH-n, the apparatus controller 159 does not exercise the feedback control over the attenuator 165ₙ based on an optical power level detected by the second photodiode 167ₙ corresponding to the channel CH-n. In other words, the apparatus controller 159 carries out shutdown control for the channel CH-n where no optical signal has been transmitted to shut off the optical signal output from the second optical splitter 166ₙ to the second arrayed waveguide grating 168.

On the other hand, even when the optical power level detected by the first photodiode 164ₙ is higher than the no-signal criterion level L₁ and it has been determined that an optical signal was input to the channel CH-n, an optical power level output from the second photodiode 167ₙ corresponding to the channel CH-n may be left abnormally low. In this case, it is determined that the channel CH-n is in a no input state where the feedback control with the use of the attenuator 165ₙ and the second photodiode 167ₙ corresponding to the channel CH-n is not exercised normally and the insertion loss cannot be adjusted. Therefore, when an optical power level output from the second photodiode 167ₙ of the channel CH-n is equal to or lower than a no input criterion level or LOS (Loss Of Signal) level L₂, the apparatus controller 159 determines that an optical signal is shut off due to a failure in the attenuator 165ₙ of the channel CH-n.

Incidentally, the apparatus controller 159 comprises a CPU (Central Processing Unit), a ROM (Read Only Memory) for storing a control program and a RAM (Random Access Memory) as a work memory, which are not shown in the drawing. In addition, the output of the respective first photodiodes 164₁ to 164ₙ and second photodiodes 167₁ to 167ₙ in the level equalizer 154 is input to the apparatus controller 159 via an interface circuit (not shown). Based on the output or detection results, the apparatus controller 159 controls the insertion loss caused by the attenuators 165₁ to 165ₙ to shut down a specific channel, etc., and also detects a failure in the attenuators 165₁ to 165n.

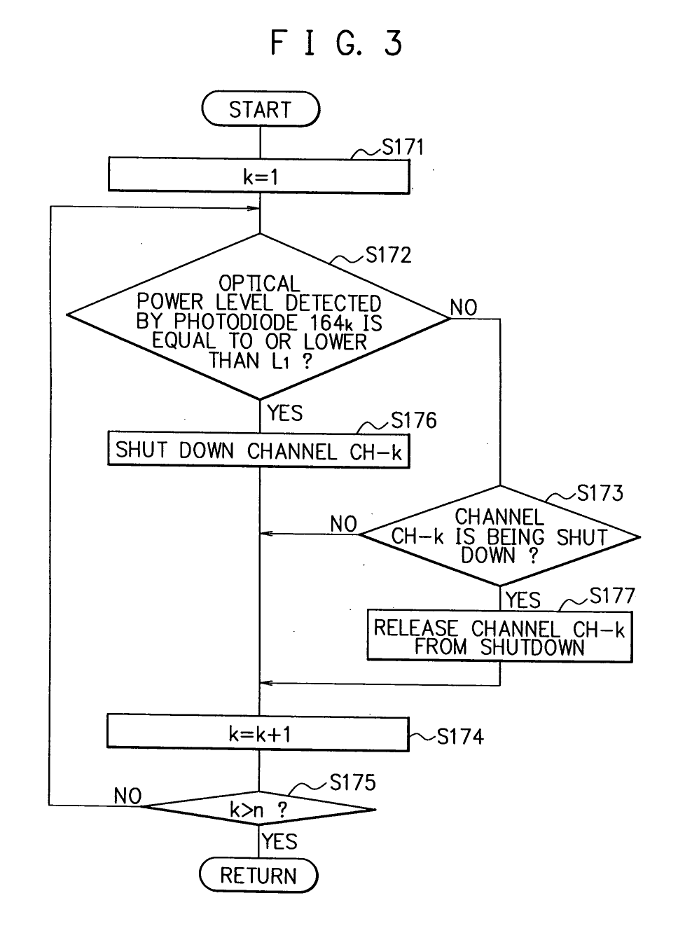

FIG. 3 is a flowchart showing the operation of the apparatus controller for the shutdown control according to the first embodiment of the present invention. Referring to FIG. 3, a description will be made of the shutdown control performed by the apparatus controller 159.

First, when the optical intermediate node with a level equalizer 150 is activated, the aforementioned CPU of the apparatus controller 159 initializes the parameter k, which indicates a channel, to “1” (step S171). Subsequently, the apparatus controller 159 determines whether or not the optical power level of the k-th channel (here, channel CH-1) detected by the first photodiode 164₁ is equal to or lower than the no-signal criterion level L₁ (step S172). When the optical power level is normal or higher than the no-signal criterion level L₁ (step S172, NO), the CPU of the apparatus controller 159 refers data stored in the aforementioned RAM to check whether or not the channel CH-1 is being shut down (step S173). If the optical power level found out by the previous detection is also normal, and the shutdown control has not been carried out (step S173, NO), the apparatus controller 159 increments the parameter k by “1” (step S174). After that, the apparatus controller 159 compares the incremented parameter k with the number of channels n (step S175). When the parameter k is smaller than the number of channels n (step S175, NO), control is returned to step S172 to repeat the same process for the next channel.

When no proper optical signal is present in the n-th channel, the optical power level of the channel CH-n detected by the first photodiodes 164ₙ is equal to or lower than the no-signal criterion level L₁ in the n-th operation after the initialization of the parameter k (step S172, YES). In this case, the CPU of the apparatus controller 159 shuts down the channel CH-n (step S176). By the shutdown control, the insertion loss caused by the attenuator 165ₙ corresponding to the channel CH-n is increased to maximum. Besides, if a flag corresponding to the channel CH-n in the area of the RAM has not been set to “1”, then the flag is set to “1”. After that, the apparatus controller 159 increments the parameter k by “1” (step S174). When the parameter k exceeds the number of channels n (step S175, YES), control is returned to step S171, and the parameter k is initialized to “1” again. Thus, the next cycle of the operation is taken place. As described above, when a channel where no proper optical signal is present (a channel in a no signal state) is found in a certain cycle of the operation, the shutdown control is exercised for the channel.

The above-mentioned operation is continuously carried out while the optical intermediate node with a level equalizer 150 shown in FIG. 2 is active. Consequently, even if the channel CH-n is once shut down in a certain cycle of the operation, it can be released from the shutdown control. For example, in the case where an optical signal is transmitted to the channel CH-n again due to a recovery from a line failure or the like after the channel CH-n was shut down, the optical power level detected by the first photodiode 164ₙ exceeds the no-signal criterion level L₁ (step S172, NO). Thereby, the CPU of the apparatus controller 159 refers data stored in the RAM to check whether or not the channel CH-1 is being shut down (step S173). When the apparatus controller 159 determines that the channel CH-1 is being shut down (step S173, YES), it releases the channel CH-1 from the shutdown control (step S177). In other words, the insertion loss at the attenuator 165ₙ corresponding to the channel CH-n is to be adjusted according to the optical power level detected by the second photodiode 167ₙ. Additionally, the flag corresponding to the channel CH-n in the shutdown area of the RAM is reset to “0”.

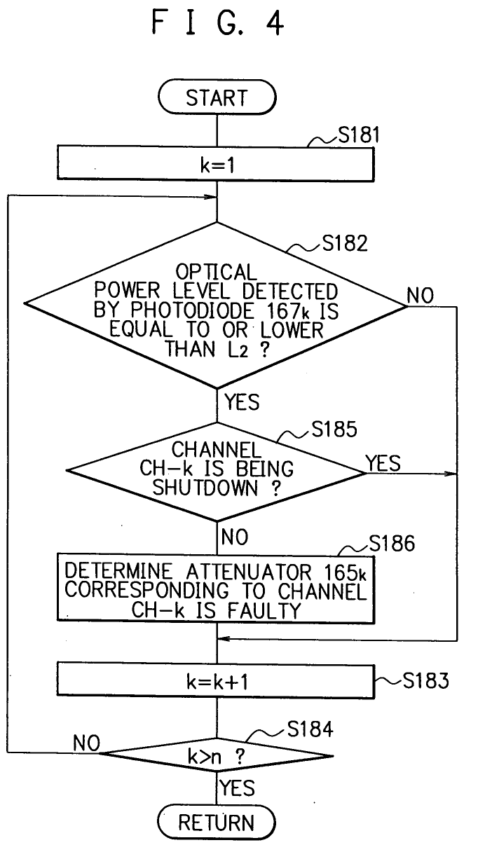

FIG. 4 is a flowchart showing the operation of the apparatus controller for detecting failures in the attenuators according to the first embodiment of the present invention. Referring to FIG. 4, a description will be made of the failure detection control executed by the apparatus controller 159.

First, when the optical intermediate node with a level equalizer 150 is activated, the CPU of the apparatus controller 159 initializes the parameter k, which indicates a channel, to “1” (step S181). Subsequently, the apparatus controller 159 determines whether or not the optical power level of the k-th channel (here, channel CH-1) detected by the second photodiode 167₁ is equal to or lower than the LOS level L₂ (step S182). When the optical power level is higher than the LOS level L₂ (step S182, NO), at any rate, the insertion loss at the attenuator 165₁ corresponding to the channel CH-1 is not fixed at the maximum value. Accordingly, the apparatus controller 159 increments the parameter k by “1” (step S183). After that, the apparatus controller 159 compares the incremented parameter k with the number of channels n (step S184). When the parameter k is smaller than the number of channels n (step S184, NO), control is returned to step S182 to repeat the same process for the next channel.

When no proper optical signal is present in the n-th channel, the optical power level of the channel CH-n detected by the first photodiode 164ₙ is equal to or lower than the no-signal criterion level L₁ in the n-th operation after the initialization of the parameter k (step S172 in FIG. 3, YES). In this case, as previously described for step S176 in FIG. 3, a flag corresponding to the channel CH-n in the shutdown area of the RAM is set to “1” (even when the process for the channel CH-n shown in FIG. 4 is performed previous to the process in FIG. 3, the flag corresponding to the channel CH-n in the shutdown area is set to “1” in the next cycle of the operation). Accordingly, when the optical power level of the channel CH-n detected by the second photodiode 167ₙ is equal to or lower than the LOS level L₂ (step S182, YES), the CPU of the apparatus controller 159 checks whether or not the flag corresponding to the channel CH-n has been set to “1”. Thus, the apparatus controller 159 determines whether or not the channel CH-n is being shut down, that is, whether or not the channel CH-n is in the no signal state (step S185).

When the channel CH-n is being shut down (step S185, YES), the insertion loss caused by the attenuator 165ₙ of the channel CH-n has been increased to maximum. Therefore, it is normal that the optical power level of the channel CH-n detected by the second photodiode 167ₙ is lower than the LOS level L₂. Accordingly, in this case, control proceeds to step S183 without performing any specific process. Thus, the next cycle of the operation is taken place.

On the other hand, when the channel CH-n is not being shut down (step S185, NO), it turns out that an optical signal has been input to the channel CH-n. Nevertheless, if the optical power level of the channel CH-n detected by the second photodiode 167ₙ is equal to or lower than the LOS level L₂, the CPU of the apparatus controller 159 determines that the attenuator 165ₙ corresponding to the channel CH-n is faulty (step S186). Incidentally, when the second photodiode 167ₙ is faulty, the optical power level of the channel CH-n detected by the second photodiodes 167ₙ may also be equal to or lower than the LOS level L₂. Therefore, the apparatus controller 159 may determine that a failure has occurred in either the attenuator 165ₙ or the second photodiodes 167ₙ.

As set forth hereinabove, according to the first embodiment of the present invention, the power levels of the optical signals of the respective channels demultiplexed by the first arrayed waveguide grating 161 are detected by the first photodiodes 164₁ to 164ₙ. Thereby, it is possible to detect the arrival of a proper optical signal, and also the power level of an optical signal which has leaked from one channel into another channel where no proper optical signal is present. In addition, the optical signals of the respective channels can be analyzed by comparing optical power levels detected by the first photodiodes 164₁ to 164ₙ in the form of spectrum analysis of characteristics of the transmission line for transmitting a multiplexed optical signal.

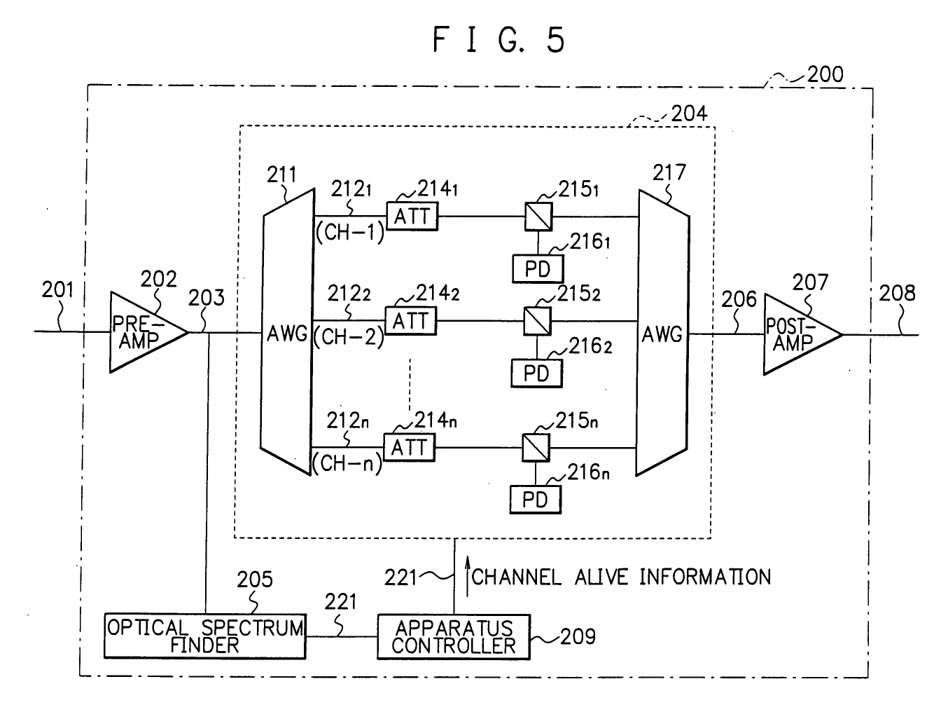

FIG. 5 is a block diagram showing the substantial part of an optical intermediate node provided with a level equalizer using an optical power control apparatus according to the second embodiment of the present invention. Referring to FIG. 5, the optical intermediate node with a level equalizer 200 comprises a pre-amplifier 202, a level equalizer 204, an optical spectrum finder 205, a post-amplifier 207, and an apparatus controller 209.

The pre-amplifier 202 amplifies a WDM optical signal 201 input thereto. The WDM optical signal 203 output from the pre-amplifier 202 is input to the level equalizer 204 and the optical spectrum finder 205. The level equalizer 204 equalizes the power levels of the optical signals (the WDM optical signal 203) with respect to each wavelength. The optical spectrum finder 205 measures the spectrum of the WDM optical signal 203. After the optical power levels of respective wavelengths are equalized by the level equalizer 204, the WDM optical signal 206 output from the level equalizer 204 is input to the post-amplifier 207. The post-amplifier 207 amplifies the WDM optical signal 206, and outputs the WDM optical signal 208. Thus, the WDM optical signal 208 is transmitted from the optical intermediate node with a level equalizer 200 to the outside.

The apparatus controller 209 is connected to the level equalizer 204 and the optical spectrum finder 205 to control various managements in the optical intermediate node with a level equalizer 200. The optical spectrum finder 205 generally measures characteristics of a multiplexed optical signal with respect to each wavelength, such as the power level, center frequency and S/N (signal-to-noise) ratio, which are utilized for evaluating transmission performance.

The level equalizer 204 of the second embodiment includes a first arrayed waveguide grating (AWG) 211, attenuators (ATT) 214, to 214ₙ, optical splitters 215₁ to 215ₙ, photodiodes (PD) 216₁ to 216ₙ, and a second arrayed waveguide grating 217.

When the WDM optical signal 203 output from the pre-amplifier 202 is input to the first arrayed waveguide grating 211, the first arrayed waveguide grating 211 demultiplexes the WDM optical signal 203 into optical signals 212₁ to 212ₙ having different wavelengths. Channels CH-1 to CH-n are allocated for the optical signals 212₁ to 212ₙ, respectively. The demultiplexed optical signals 212₁ to 212ₙ of the channels CH-1 to CH-n are input to the corresponding attenuators 214₁ to 214ₙ, respectively. The attenuators 214₁ to 214ₙ attenuate the levels of the optical signals 212₁ to 212ₙ, respectively, to a desired value by adjusting the insertion loss. The apparatus controller 209 controls the adjustments.

The optical splitters 215₁ to 215ₙ are set on the output side of the attenuators 214₁ to 214ₙ. The optical splitters 215₁ to 215ₙ split the input optical signals 212₁ to 212ₙ, respectively. One output from the optical splitter (215₁ to 215ₙ) is input to the corresponding photodiode (216₁ to 216ₙ). The photodiode 216₁ to 216ₙ detect the power levels of the optical signals which have passed through the attenuators 214₁ to 214ₙ. The other output from the respective optical splitters 215₁ to 215ₙ is input to the second arrayed waveguide grating 217. The second arrayed waveguide grating 217 multiplexes the optical signals 212₁ to 212ₙ each having a different wavelength. The WDM optical signal 206 output from the second arrayed waveguide grating 217 is amplified by the post-amplifier 207 as described previously. After that, the WDM optical signal 208 output from the post-amplifier 207 is transmitted from the optical intermediate node with a level equalizer 200 to the outside.

In the optical intermediate node with a level equalizer 200 according to the second embodiment of the present invention, the optical spectrum finder 205 measures characteristics of the WDM optical signal 203 to determine whether there is an optical signal with respect to each wavelength. The measurement results or determination results are sent to the apparatus controller 209 as channel alive information 221, and passed to the level equalizer 204. When, for example, the attenuator 214 corresponding to the channel CH-n is faulty, the level equalizer 204 increases the insertion loss caused by the attenuator 214ₙ to maximum based on the channel alive information 221. Thus, shutdown control is carried out for the optical signal of the channel CH-n.

Besides, there is the case where the channel CH-n is determined to be in the no input state according to the output of the photodiode 216ₙ set on the output side of the attenuator 214ₙ, although it has been determined that an optical signal was input to the channel CH-n based on the channel alive information 221. In this case, it is determined that an optical signal has been shut off due to a failure which occurred in the attenuator 214ₙ corresponding to the channel CH-n. In the following, a concrete description will be given of this case.

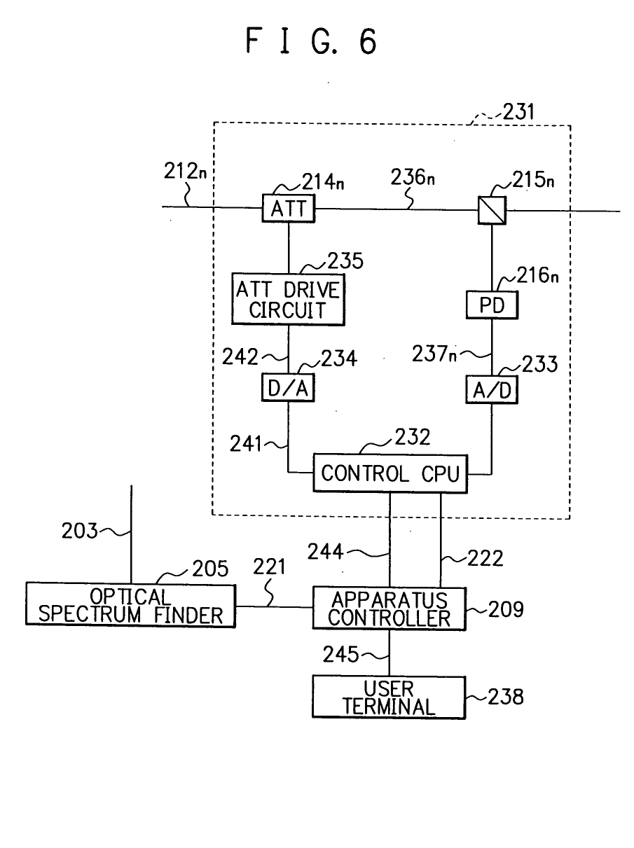

FIG. 6 is a block diagram showing a level equalizer ATT controller and a circuit part related thereto according to the second embodiment of the present invention. The level equalizer ATT controller 231, which is not seen in FIG. 5, is located in the level equalizer 204. The level equalizer ATT controller 231 includes the attenuators 214₁ to 214ₙ, the optical splitters 215₁ to 215ₙ, and the photodiodes 216₁ to 216ₙ shown in FIG. 5, only one of each, namely the attenuator 214ₙ, the optical splitter 215ₙ, and the photodiode 216ₙ corresponding to the channel CH-n being shown in FIG. 6 for simplicity. The level equalizer ATT controller 231 further includes a control CPU 232, an A/D converter (A/D) 233, a D/A converter (D/A) 234 and an ATT drive circuit 235.

The A/D converter 233 feeds the control CPU 232 with the output of the photodiode 216ₙ as digital data. The D/A converter 234 carries out a digital-analog conversion to convert the data of the insertion loss calculated by the control CPU 232 to analog data. The ATT drive circuit 235 implements the increasing and decreasing of the insertion loss caused by the attenuator 214ₙ corresponding to the channel CH-n based on the analog data output from the D/A converter 234.

The level equalizer ATT controller 231 includes the attenuator (214₁ to 214ₙ), the optical splitter (215₁ to 215ₙ), and the photodiode (216₁ to 216ₙ) with respect to each channel. In the similar manner, there are as many A/D converters (233), D/A converters (234) and ATT drive circuits (235) as there are channels (the number of channels n). However, if the circuits are capable of time-sharing processing, it is possible to reduce the number of circuits.

The attenuator 214ₙ is fed with the optical signal 212ₙ of the channel CH-n from the first arrayed waveguide grating 211 shown in FIG. 5. The insertion loss at the attenuator 214ₙ is controlled by the ATT drive circuit 235. The optical signal 236ₙ of the channel CH-n output from the attenuator 214ₙ is input to the optical splitter 215ₙ. The optical splitter 215ₙ splits the optical signal 236ₙ. One output of the optical splitter 215ₙ is input to the second arrayed waveguide grating 217, while the other output is input to the photodiode 216ₙ corresponding to the channel CH-n. The photodiode 216ₙ detects the power level of the optical signal, and outputs the detection result to the A/D converter 233 as the optical signal 237ₙ of the channel CH-n. The control CPU 232 executes a control program stored in a ROM (not shown) to achieve various controls in the level equalizer ATT controller 231 as well as collecting information. With regard to the optical signal 237ₙ of the channel CH-n shown in FIG. 6, the control CPU 232 checks the optical power level of the signal which has been converted into a digital signal by the A/D converter 233 to determine whether or not the power level of the optical signal 236ₙ of the channel CH-n is equal to or lower than the LOS level L₂ previously mentioned in the first embodiment.

The optical spectrum finder 205 measures the spectrum of the WDM optical signal 203 (shown in FIG. 5). In this example, it is determined whether there is an optical signal with a wavelength for the channel CH-n based on the relationship between the optical power level of spectrum components corresponding to the wavelength and the S/N ratio. The output of the optical spectrum finder 205 indicating the presence or absence of an optical signal with respect to each channel is sent to the apparatus controller 209 as the channel alive information 221.

The apparatus controller 209 includes a CPU (not shown) and a recording medium (not shown) such as a ROM for storing a program executed by the CPU. As can be seen in FIG. 6, the apparatus controller 209 is connected with a user terminal 238 and also respective parts of the optical intermediate node with a level equalizer 200 to gather various types of information and provide settings. For example, the user terminal 238 is connected to the apparatus controller 209 via an interface circuit (not shown). A user can make a variety of settings for the optical intermediate node with a level equalizer 200 through the apparatus controller 209 by operating the user terminal 238. In addition, necessary information on the conditions of the circuits in the optical intermediate node with a level equalizer 200 is sent from the apparatus controller 209 to the user terminal 238. Thus, the user is notified of the information through a display or a speaker (not shown) of the user terminal 238.

The apparatus controller 209 sends the channel alive information 221 to the control CPU 232 as described previously. When having determined that there is no optical signal input in the channel CH-n according to the channel alive information 221, the control CPU 232 carries out the shutdown control to shut off an optical signal output from the level equalizer ATT controller 231 with regard to the channel CH-n. Accordingly, the control CPU 232 sends the D/A converter 234 an ATT drive circuit control signal 241 for increasing the insertion loss at the attenuator 214ₙ to maximum. The D/A converter 234 carries out a D/A conversion to convert the ATT drive circuit control signal 241 into an analog signal. The ATT drive circuit control signal 241 converted into an analog signal is supplied to the ATT drive circuit 235. When the ATT drive circuit control signal 241 indicates that there is no optical signal input in the channel CH-n, the ATT drive circuit 235-controls the insertion loss of the optical signal 212ₙ so as to be maximum.

On the other hand, in the case where the channel alive information 221 indicates that there is optical signal input in the channel CH-n and also an optical power level detected by the photodiode 216ₙ corresponding to the channel CH-n is equal to or lower than the LOS level L₂, the control CPU 232 determines that the optical power level has been reduced due to a failure in the attenuator 214ₙ corresponding to the channel CH-n. In this case, the control CPU 232 sends the apparatus controller 209 an attenuator failure warning message 244 for informing the apparatus controller 209 of a failure in the attenuator 214ₙ. Having received the attenuator failure warning message 244, the apparatus controller 209 sends it to the user terminal 238.

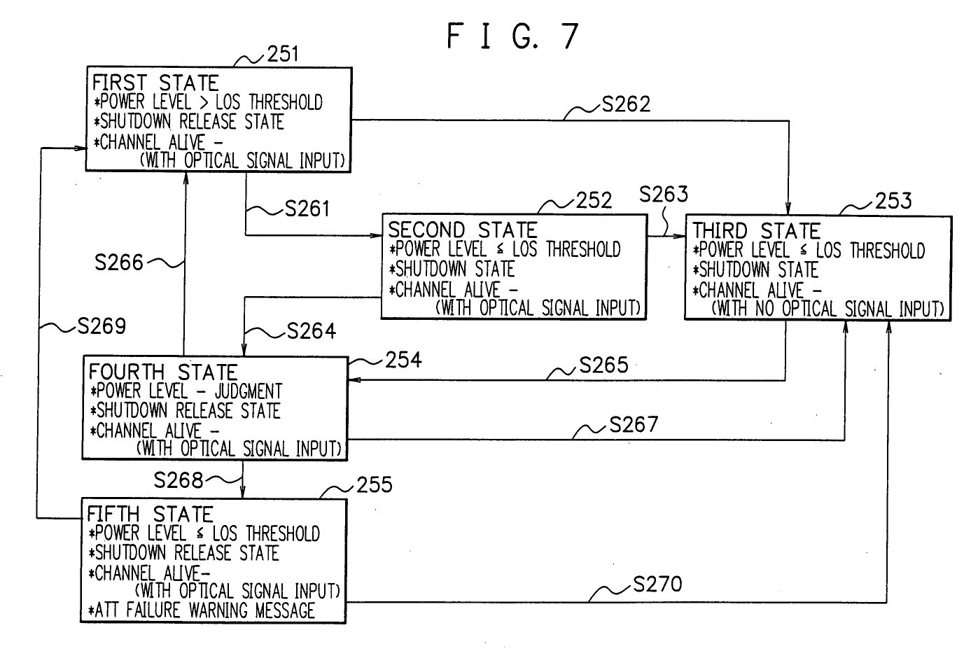

FIG. 7 is a state transition diagram showing the operation of the level equalizer ATT controller according to the second embodiment of the present invention. Referring to FIG. 7, the level equalizer ATT controller 231 shown in FIG. 6 may be in the five different states (first state 251 to fifth state 255) as will be described below. Incidentally, the control CPU 232 is provided with the no input criterion level (LOS level) L₂ as a threshold to detect the absence of optical signal input or the loss of a signal. The control CPU 232 determines that there has been no optical signal input when detected value is lower than the LOS level L₂. In the following, a description will be given of the first state 251 to the fifth state 255 of the level equalizer ATT controller 231.

[First State 251]

In the first state 251, the channel alive information 221 obtained from the optical spectrum finder 205 shown in FIG. 6 through the apparatus controller 209 indicates the presence of optical signal input, and an optical power level detected by the photodiode 216ₙ corresponding to the relevant channel (the channel CH-n will be taken as an example in the following description) is higher than the LOS level L₂. Besides, in the first state 251, the control CPU 232 has not performed the shutdown control to increase the insertion loss at the attenuator 214ₙ corresponding to the channel CH-n to maximum. Consequently, in the first state 251, the insertion loss caused by the attenuator 214ₙ corresponding to the channel CH-n is adjusted so that the optical power level detected by the corresponding photodiode 216ₙ is to be a preset desired value.

[Second State 252]

In the second state 252, the channel alive information 221 obtained from the optical spectrum finder 205 through the apparatus controller 209 indicates the presence of optical signal input. Under the circumstances, the control CPU 232 has performed the shutdown control to increase the insertion loss at the attenuator 214ₙ corresponding to the channel CH-n to maximum. As a result, an optical power level detected by the photodiode 216ₙ corresponding to the channel CH-n is equal to or lower than the LOS level L₂.

[Third State 253]

In the third state 253, the channel alive information 221 obtained from the optical spectrum finder 205 through the apparatus controller 209 indicates the absence of optical signal input. Under the circumstances, the control CPU 232 has performed the shutdown control to increase the insertion loss at the attenuator 214ₙ corresponding to the channel CH-n to maximum. As a result, an optical power level detected by the photodiode 216ₙ corresponding to the channel CH-n is equal to or lower than the LOS level L₂.

[Fourth State 254]

In the fourth state 254, the channel alive information 221 obtained from the optical spectrum finder 205 through the apparatus controller 209 indicates the presence of optical signal input, and the control CPU 232 has not performed the shutdown control to increase the insertion loss at the attenuator 214ₙ corresponding to the channel CH-n to maximum. The fourth state 254 is a transient state, and the transition from the fourth state 254 to any other state is determined according to an optical power level detected by the photodiode 216ₙ corresponding to the channel CH-n.

[Fifth State 255]

In the fifth state 255, the channel alive information 221 obtained from the optical spectrum finder 205 through the apparatus controller 209 indicates the presence of optical signal input, and an optical power level detected by the photodiode 216ₙ corresponding to the channel CH-n is equal to or lower than the LOS level L₂. Besides, the control CPU 232 has not performed the shutdown control to increase the insertion loss at the attenuator 214ₙ corresponding to the channel CH-n to maximum. In the fifth state 255, the control CPU 232 determines that a failure has occurred in the attenuator 214ₙ corresponding to the channel CH-n, and sends the attenuator failure warning message 244 to the apparatus controller 209.

Next, the directions of the transition among the first to fifth states and triggers for the transition will be explained.

[Transition from First State 251 to Second State 252]

When an optical power level detected by the photodiode 216ₙ corresponding to the channel CH-n is decreasing in the first state 251 (step S261), the detected optical power level eventually becomes equal to or lower than the LOS level L₂. Thereby, the level equalizer ATT controller 231 increases the insertion loss at the attenuator 214ₙ corresponding to the channel CH-n to maximum so as to shut off optical power (transition to the second state 252).

[Transition from First State 251 to Third State 253]

When the channel alive information 221 obtained from the optical spectrum finder 205 through the apparatus controller 209 which has indicated the presence of optical signal input in the first state 251 indicates the absence of optical signal input (step S262), the level equalizer ATT controller 231 increases the insertion loss at the attenuator 214ₙ corresponding to the channel CH-n to maximum so as to shut off optical power (transition to the third state 253).

[Transition from Second State 252 to Third State 253]

When the channel alive information 221 obtained from the optical spectrum finder 205 through the apparatus controller 209 which has indicated the presence of optical signal input in the channel CH-n in the second state 252 indicates the absence of optical signal input (step S263), a transition to the third state 253 takes place.

[Transition from Second State 252 to Fourth State 254]

After a certain lapse of time in the second state 252, when a protected time, which will be described later, to obtain the channel alive information 221 has passed (step S264), the transition from the second state 252 to the fourth state 254 automatically takes place. Having received the channel alive information 221 from the optical spectrum finder 205, the apparatus controller 209 processes the information 221 by software, and forwards it to the level equalizer ATT controller 231. Because of the software processing, prescribed delay occurs in the level equalizer ATT controller 231's obtaining the channel alive information 221. Additionally, since the optical spectrum finder 205 periodically takes measurements, there is a time lag between the loss of optical signal input in the channel CH-n and the arrival of the channel alive information 221 for reporting it at the level equalizer ATT controller 231. These delays are referred to as protected time. When the channel alive information 221 still indicates the presence of optical signal input in the channel CH-n in the second state 252 after the protected time has passed, the transition from the second state 252 to the fourth state 254 takes place. Thus, the channel CH-n is released from the shutdown control.

[Transition from Third State 253 to Fourth State 254]

When the channel alive information 221 obtained from the optical spectrum finder 205 through the apparatus controller 209 which has indicated the absence of optical signal input in the channel CH-n in the third state 253 indicates the presence of optical signal input (step S265), a transition to the fourth state 254 takes place, and the level equalizer ATT controller 231 reduces the insertion loss at the attenuator 214ₙ corresponding to the channel CH-n so that the optical power is to be output.

[Transition from Fourth State 254 to First State 251]

When the channel CH-n is released from the shutdown control in the fourth state 254, and an optical power level detected by the photodiode 216ₙ corresponding to the channel CH-n is higher than the LOS level L₂ (step S266), a transition to the first state 251 takes place.

[Transition from Fourth State 254 to Third State 253]

When the channel alive information 221 obtained from the optical spectrum finder 205 through the apparatus controller 209 which has indicated the presence of optical signal input in the fourth state 254 indicates the absence of optical signal input (step S267), a transition to the third state 253 takes place, and the level equalizer ATT controller 231 increases the insertion loss at the attenuator 214ₙ corresponding to the channel CH-n to maximum so as to shut off optical power.

[Transition from Fourth State 254 to Fifth State 255]

When the channel CH-n is released from the shutdown control in the fourth state 254, and an optical power level detected by the photodiode 216ₙ corresponding to the channel CH-n is equal to or lower than the LOS level L₂ (step S268), a transition to the fifth state 255 takes place.

[Transition from Fifth State 255 to First State 251]

When an optical power level detected by the photodiode 216ₙ corresponding to the channel CH-n which has been equal to or lower than the LOS level L₂ in the fifth state 255 becomes higher than the LOS level L₂ (step S269), a transition to the first state 251 takes place.

[Transition from Fifth State 255 to Third State 253]

When the channel alive information 221 obtained from the optical spectrum finder 205 through the apparatus controller 209 which has indicated the presence of optical signal input in the channel CH-n in the fifth state 255 indicates the absence of optical signal input (step S270), a transition to the third state 253 takes place, and the level equalizer ATT controller 231 increases the insertion loss at the attenuator 214ₙ corresponding to the channel CH-n to maximum so as to shut off optical power.

As set forth hereinabove, in accordance with the second embodiment of the present invention, it is determined whether there is an optical signal with respect to each wavelength based on the channel alive information 221 obtained from the optical spectrum finder 205 through the apparatus controller 209. When there is a channel where no optical signal has arrived, the level equalizer ATT controller 231 increases the insertion loss at the attenuator 214 corresponding to the channel to maximum. With this construction, it is not required to set photodiodes as preliminary to the attenuator 214₁ to 214ₙ to detect the absence of optical signal input or the loss of a signal for the respective channels (wavelengths). Consequently, the number of photodiodes included in the level equalizer ATT controller 231 can be reduced by half, and the level equalizer occupies less space.

In addition, according to the second embodiment of the present invention, the control CPU 232 performs processing by software based on the channel alive information 221 obtained from the optical spectrum finder 205 through the apparatus controller 209 and the result of a comparison between an optical power level detected by each photodiode set on the output side of the respective attenuators 214₁ to 214ₙ and a threshold to detect the absence of optical signal input or the loss of a signal. Besides, failure detection for the respective attenuators 214₁ to 214ₙ is carried out triggered by the transition from one state to another. Therefore, failures in the attenuators 214₁ to 214ₙ can be found out without having photodiodes as preliminary to the attenuator 214₁ to 214ₙ to detect whether there is an optical signal demultiplexed by the arrayed waveguide grating with respect to each wavelength.

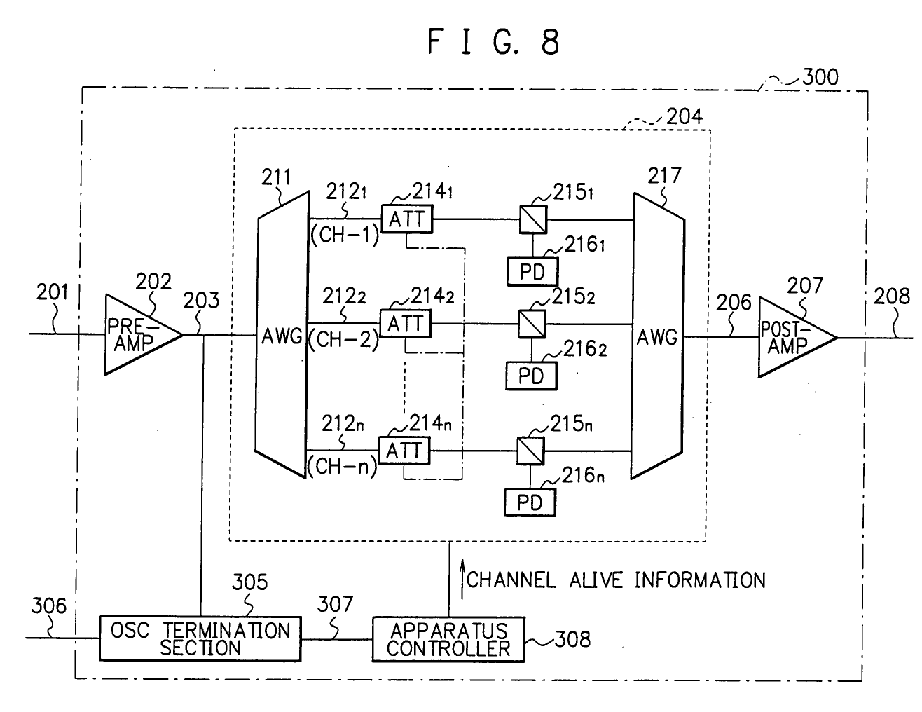

FIG. 8 is a block diagram showing the substantial part of an optical intermediate node provided with a level equalizer using an optical power control apparatus according to the third embodiment of the present invention. The optical intermediate node provided with a level equalizer shown in FIG. 8 is in many respects basically similar to that of FIG. 5, and similar numbers are utilized in designating corresponding portions. It is believed that a full description of these portions is unnecessary.

Referring to FIG. 8, the optical intermediate node with a level equalizer 300 of this embodiment includes a pre-amplifier 202, a level equalizer 204, and a post-amplifier 207 as with the optical intermediate node with a level equalizer 200 shown in FIG. 5.

The pre-amplifier 202 amplifies a WDM optical signal 201 input thereto. The level equalizer 204 set on the output side of the pre-amplifier 202 equalizes the power levels of the optical signals with respect to each wavelength. The post-amplifier 207 amplifies the WDM optical signal 206 which has passed through the level equalizer 204, and outputs the WDM optical signal 208. Thus, the WDM optical signal 208 is transmitted from the optical intermediate node with a level equalizer 300 to the outside.

On the other hand, the optical intermediate node with a level equalizer 300 of this embodiment is not provided with a circuit part corresponding to the optical spectrum finder 205 differently from the optical intermediate node with a level equalizer 200 of FIG. 5. However, the optical intermediate node with a level equalizer 300 has an OSC (Optical Service Channel) termination section 305 instead as a means for obtaining the channel alive information. The OSC termination section 305 terminates an OSC signal 306 for reporting apparatus management information. In a wavelength division multiplexing system, it is possible to monitor signals to be multiplexed at an end station. Therefore, in such optical transport system, channel alive information as to the presence or absence of an optical signal with respect to each wavelength before multiplexing is collected, and sent to the optical intermediate node with a level equalizer 300 as the OSC signal 306. In the third embodiment of the present invention, the OSC termination section 305 which terminates the OSC signal 306 transmits the channel alive information 307 to the apparatus controller 308. Thereafter, the apparatus controller 308 forwards the channel alive information 307 to the level equalizer 204.

When the level equalizer 204 determines that, for example, there is no optical signal input in the channel CH-n based on the channel alive information 307, the ATT drive circuit 235 shown in FIG. 6 adjusts the insertion loss caused by the attenuator 214ₙ corresponding to the channel CH-n so that the insertion loss in the optical signal 212ₙ of the channel CH-n is increased to maximum. In this manner, the shutdown control is carried out. Besides, when the level equalizer 204 determines that there is optical signal input in the channel CH-n based on the channel alive information 307, the level equalizer 204 checks whether or not an optical power level detected by the photodiode 216ₙ corresponding to the channel CH-n is equal to or lower than a threshold, that is, no input criterion level (LOS level) L₂. When the optical power level is equal to or lower than the LOS level L₂, the level equalizer 204 determines that an optical signal is shut off due to a failure in the attenuator 214ₙ corresponding to the channel CH-n.

As just described, according to the third embodiment of the present invention, the optical intermediate node with a level equalizer 300 is not provided with the optical spectrum finder 205. However, the OSC termination section 305 obtains the channel alive information instead of the measuring of the optical spectrum, and is capable of sending the channel alive information to the level equalizer 204. Consequently, the number of photodiodes included in the level equalizer 204 can be reduced by half.

While the present invention is applied to the optical intermediate node with a level equalizer (150, 200, 300) in the above described first to third embodiments, it is not to be restricted by the embodiments. For example, in the case where the required characteristic is that an optical power level increases according to wavelength in relation to the wavelength characteristic of an optical fiber, the characteristic output from a relay station depends on the requirement. The present invention can be generally applied to any optical power control apparatus, which detects the level of each optical signal after demultiplexing a multiplexed optical signal to adjust it to a prescribed level by the insertion loss caused by an attenuator, and, when the detected signal level is equal to or lower than a prescribed threshold, increases the insertion loss at the attenuator to maximum, thereby carrying out the shutdown control.

In the above-described first to third embodiments, arrayed waveguide gratings are used for the demultiplexing of a multiplexed optical signal and subsequent multiplexing. However, the present invention can also be applied to optical power control apparatuses using other optical devises. Additionally, not all the optical signals of respective channels, which have been demultiplexed by a demultiplexer, have to be input to a multiplexer after the adjustments of their optical power levels. It is obvious that there may be a channel which perform, for example, “add-drop” (the insertion and extraction of optical signals).

Further, while attenuators are used to adjust signal levels in the above-described first to third embodiments, it is possible to use such signal level adjusting means as having an amplifying function so that signal levels can be amplified as well as can be attenuated. Besides, it is obvious that optical switches for passing or stopping the input optical signals may be set instead of signal level adjusting means for the purpose of shutting off an optical signal which leaks into one channel to another where no optical signal has arrived.

Still further, in the above described first to third embodiments, a description has been made of the case of preventing crosstalk in between multiplexed optical signals originally having the same wavelength, which arises in a waveguide when using a pair of arrayed waveguide gratings for multiplexing and demultiplexing. However, the present invention is also applicable to the case where a demultiplexer is located at the end of a plurality of waveguides.

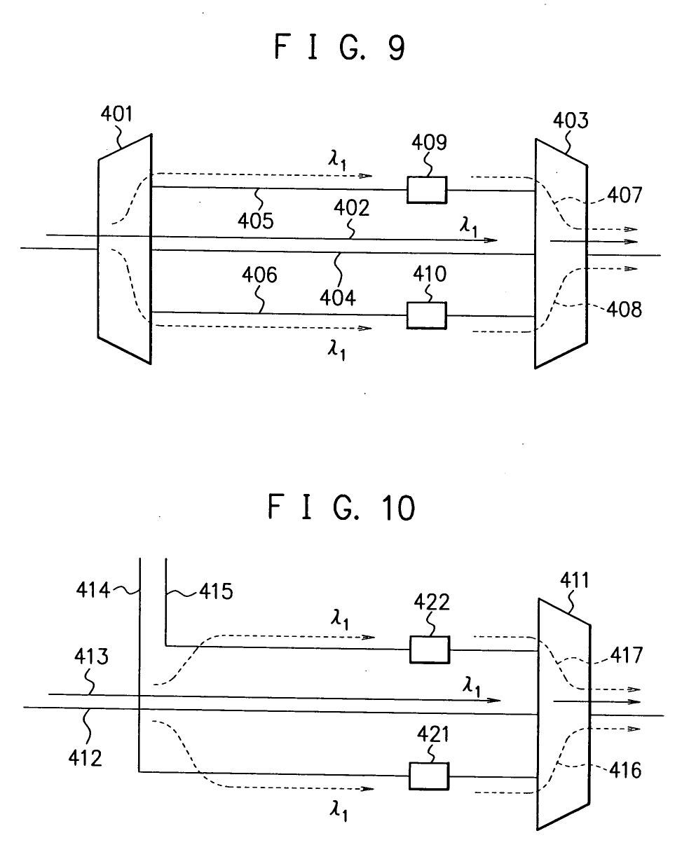

FIG. 9 is a diagram showing the principle of reductions in crosstalk produced in arrayed waveguide gratings according to the above-described embodiments of the present invention.

It is assumed that an optical signal 402 with a wavelength λ₁ is input to a first arrayed waveguide grating 401. After having been demultiplexed, the optical signal 402 reaches to a second arrayed waveguide grating 403 by passing through a waveguide 404, and also leaks into other waveguides 405 and 406 with a low signal level. Consequently, the derivative optical signal 407 with the same wavelength λ₁ which has passed through the waveguide 405 and the derivative optical signal 408 with the same wavelength λ₁ which has passed through the waveguide 406 are multiplexed by the original optical signal 402 at the second arrayed waveguide grating 403. Such crosstalk deteriorates the quality of the optical signal 402. Therefore, with a basic concept of the embodiments of the present invention, when there is no proper optical signal having a wavelength component corresponding to the waveguides 405 and 406, optical signals in the waveguides 405 and 406 are shut off by shutoff means 409 and 410 such as attenuators and switches.

FIG. 10 is a diagram showing the principle of reductions in crosstalk produced in arrayed waveguide gratings according to the modified form of the embodiments of the present invention.

In FIG. 10, an optical signal 413 with a wavelength λ₁ is input to a multiplexing arrayed waveguide grating 411 through a waveguide 412. Another waveguide 414 crosses the waveguide 412 in layers, and connected to the input end of the arrayed waveguide grating 411. Besides, another waveguide 415 is partially in close vicinity to the waveguide 412, and also connected to the input end of the arrayed waveguide grating 411. In this construction, even if the leaders of the waveguides 412, 414 and 415 are connected to different optical devices (not shown), part of the optical signal 413 with a wavelength A, leaks into the waveguides 414 and 415, and transmitted to the arrayed waveguide grating 411 therethrough. As a result, the derivative optical signals 416 and 417 are multiplexed by the original optical signal 413 at the arrayed waveguide grating 411. Such crosstalk deteriorates the quality of the optical signal 413. Therefore, when there is no proper optical signal having a wavelength component corresponding to the waveguides 414 and 415, optical signals 416 and 417 are shut off by shutoff means 421 and 422 such as attenuators and switches. Thereby, it is possible to improve the quality of the optical signal 413.

In this manner, even in the case of transmission lines allocated for optical signals demultiplexed by different demultiplexers, if the lines are connected to the same multiplexer, and there is a factor to cause a leakage of a signal midway along the lines, the present invention can be used to reduce or prevent a deterioration in the quality of the optical signal on the occasion of multiplexing.

As is described above, in accordance with the first aspect of the present invention, there is provided an optical power control apparatus comprising: a multiplexer for multiplexing two or more optical signals having different wavelengths; an optical signal transmitting section including a plurality of channels for transmitting optical signals each having a different wavelength, respectively, to the multiplexer, which allows at least part of each optical signal to leak into a channel for an optical signal having another wavelength in at least part of the channels; an optical signal transmission detector for detecting the presence or absence of optical signals transmitted through their respective proper channels (channels originally allocated for the respective signals); and switches set in the channels of the optical signal transmitting section, respectively, for shutting down the channel where no optical signal transmission has been detected by the optical signal transmission detector.

That is, according to the first aspect of the present invention, in the case where the optical power control apparatus is provided with the optical signal transmitting section in which at least a part of an optical signal with a certain wavelength leaks into a channel for another wavelength in at least part of the channels to the multiplexer, the optical signal transmission detector detects the presence of proper optical signals (optical signals transmitted through the channels originally allocated for them, respectively). Based on the detection result, the switch of each channel shuts down the channel when no optical signal transmission has been detected by the optical signal transmission detector. Thereby, it is possible to prevent the effect of coherent crosstalk noise.

In accordance with the second aspect of the present invention, there is provided an optical power control apparatus comprising: a multiplexer for multiplexing two or more optical signals having different wavelengths; an optical signal transmitting section including a plurality of channels for transmitting optical signals each having a different wavelength, respectively, to the multiplexer, which allows at least part of each optical signal to leak into a channel for an optical signal having another wavelength in at least part of the channels; an optical signal transmission detector for detecting the presence or absence of optical signals transmitted through their respective proper channels in the optical signal transmitting section; and attenuators set in the channels of the optical signal transmitting section, respectively, for increasing the insertion loss in the channel where no optical signal transmission has been detected by the optical signal transmission detector so that the insertion loss in the channel becomes greater than the insertion loss that occurs when transmitting a proper optical signal.

That is, according to the second aspect of the present invention, in the case where the optical power control apparatus is provided with the optical signal transmitting section in which at least part of an optical signal with a certain wavelength leaks into a channel for another wavelength in at least part of the channels to the multiplexer, the optical signal transmission detector detects the presence of proper optical signals. The attenuator of each channel increases the insertion loss in the channel where no optical signal transmission has been detected so that the insertion loss in the channel becomes greater than the insertion loss that occurs when transmitting a proper optical signal. Thus, the quantity of leakage signals to be multiplexed by the multiplexer is reduced, which enables a reduction in the effect of coherent crosstalk noise.

In accordance with the third aspect of the present invention, there is provided an optical power control apparatus comprising: a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels; demultiplexed signal level detectors set in the channels, respectively, for detecting the power levels of the optical signals; an optical signal detector for deciding whether or not the power level of each optical signal detected by the demultiplexed signal level detector set in each channel is lower than the lowest level of an received optical signal to detect optical signal input with respect to each channel; switches set in the channels, respectively, for passing or stopping the input optical signals of the respective channels demultiplexed by the demultiplexer; a multiplexer for multiplexing the optical signals of the respective channels, which have passed through the switches; and a switch controller which controls the respective switches so as to shut down the channel where no optical signal input has been detected by the optical signal detector.

That is, according to the third aspect of the present invention, after the demultiplexer has demultiplexed a multiplexed optical signal obtained by multiplexing optical signals with different wavelengths each corresponding to one channel, the demultiplexed signal level detectors detects the power levels of the optical signals of the respective channels. Then, the optical signal detector determines whether or not the power level of each optical signal is lower than the lowest received signal level to detect optical signal input with respect to each channel. Besides, switches are set preliminary to the multiplexing of the optical signals by the multiplexer for shutting down the channel where no proper optical signal is being transmitted under the control of the switch controller. Consequently, a leakage signal in the channel is not to be multiplexed by the multiplexer. Thereby, it is possible to prevent the effect of coherent crosstalk noise.

In accordance with the fourth aspect of the present invention, there is provided an optical power control apparatus comprising: a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels; demultiplexed signal level detectors set in the channels, respectively, for detecting the power levels of the optical signals; an optical signal detector for deciding whether or not the power level of each optical signal detected by the demultiplexed signal level detector set in each channel is lower than the lowest level of an received optical signal to detect optical signal input with respect to each channel; signal level adjusting sections set in the channels, respectively, for adjusting the levels of the optical signals of the respective channels demultiplexed by the demultiplexer; a multiplexer for multiplexing the optical signals of the respective channels, which have passed through the signal level adjusting sections; and a signal level adjusting section controller which controls the respective signal level adjusting sections so as to attenuate the level of the optical signal of the channel where no optical signal input has been detected by the optical signal detector to the greatest extent possible.

That is, according to the fourth aspect of the present invention, after the demultiplexer has demultiplexed a multiplexed optical signal obtained by multiplexing optical signals with different wavelengths each corresponding to one channel, the demultiplexed signal level detectors detects the power levels of the optical signals of the respective channels. Then, the optical signal detector determines whether or not the power level of each optical signal is lower than the lowest received signal level to detect optical signal input with respect to each channel. Besides, signal level adjusting sections are set preliminary to the multiplexing of the optical signals by the multiplexer for attenuating the level of the optical signal of the channel where no proper optical signal is being transmitted under the control of the signal level adjusting section controller. Consequently, a leakage signal in the channel is attenuated to the greatest extent possible. Thereby, it is possible to reduce the effect of coherent crosstalk noise.

In accordance with the fifth aspect of the present invention, there is provided an optical power control apparatus comprising: a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels; a spectrum analyzer for analyzing the spectrum of the multiplexed optical signal before being demultiplexed by the demultiplexer; a wavelength-specific signal level detector for detecting the power levels of the optical signals of the respective channels based on the analysis result obtained by the spectrum analyzer; an optical signal detector for deciding whether or not the power level of the optical signal detected by the wavelength-specific signal level detector with respect to each wavelength is lower than the lowest level of an received optical signal to detect optical signal input in each channel; switches set in the channels, respectively, for passing or stopping the input optical signals of the respective channels demultiplexed by the demultiplexer; a multiplexer for multiplexing the optical signals of the respective channels, which have passed through the switches; and a switch controller which controls the respective switches so as to shut down the channel where no optical signal input has been detected by the optical signal detector.

That is, according to the fifth aspect of the present invention, after the demultiplexer has demultiplexed a multiplexed optical signal obtained by multiplexing optical signals with different wavelengths each corresponding to one channel, the wavelength-specific signal level detector detects the power levels of the optical signals of the respective channels based on the analysis result obtained by the spectrum analyzer. Then, the optical signal detector determines whether or not the power level of the optical signal with respect to each wavelength is lower than the lowest received signal level to detect optical signal input in each channel. Besides, switches are set preliminary to the multiplexing of the optical signals by the multiplexer for shutting down the channel where no proper optical signal is being transmitted under the control of the switch controller. Consequently, a leakage signal in the channel is not to be multiplexed by the multiplexer. Thereby, it is possible to prevent the effect of coherent crosstalk noise.

In accordance with the sixth aspect of the present invention, there is provided an optical power control apparatus comprising: a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels; a spectrum analyzer for analyzing the spectrum of the multiplexed optical signal before being demultiplexed by the demultiplexer; a wavelength-specific signal level detector for detecting the power levels of the optical signals of the respective channels based on the analysis result obtained by the spectrum analyzer; an optical signal detector for deciding whether or not the power level of the optical signal detected by the wavelength-specific signal level detector with respect to each wavelength is lower than the lowest level of an received optical signal to detect optical signal input in each channel; signal level adjusting sections set in the channels, respectively, for adjusting the levels of the optical signals of the respective channels demultiplexed by the demultiplexer; a multiplexer for multiplexing the optical signals of the respective channels, which have passed through the signal level adjusting sections; and a signal level adjusting section controller which controls the respective signal level adjusting sections so as to attenuate the level of the optical signal of the channel where no optical signal input has been detected by the optical signal detector to the greatest extent possible.

That is, according to the sixth aspect of the present invention, after the demultiplexer has demultiplexed a multiplexed optical signal obtained by multiplexing optical signals with different wavelengths each corresponding to one channel, the wavelength-specific signal level detector detects the power levels of the optical signals of the respective channels based on the analysis result obtained by the spectrum analyzer. Then, the optical signal detector determines whether or not the power level of the optical signal with respect to each wavelength is lower than the lowest received signal level to detect optical signal input in each channel. Besides, signal level adjusting sections are set preliminary to the multiplexing of the optical signals by the multiplexer for attenuating the level of the optical signal of the channel where no proper optical signal is being transmitted under the control of the signal level adjusting section controller. Consequently, a leakage signal in the channel is attenuated to the greatest extent possible. Thereby, it is possible to reduce the effect of coherent crosstalk noise.

In accordance with the seventh aspect of the present invention, there is provided an optical power control apparatus comprising: a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels; a supervisory signal receiver for receiving a supervisory signal indicating whether there is transmission of at least part of the optical signals of the respective channels which form the multiplexed optical signal input to the demultiplexer; switches set in the channels, respectively, for passing or stopping the input optical signals of the respective channels demultiplexed by the demultiplexer; a multiplexer for multiplexing the optical signals of the respective channels, which have passed through the switches; and a switch controller which controls the respective switches so as to shut down each channel when the supervisory signal receiver has determined that no optical signal was transmitted to the channel.

That is, according to the seventh aspect of the present invention, after the demultiplexer has demultiplexed a multiplexed optical signal obtained by multiplexing optical signals with different wavelengths each corresponding to one channel, the supervisory signal receiver receives the supervisory signal indicating whether there is transmission of at least part of the optical signals of the respective channels which form the multiplexed optical signal input to the demultiplexer. Besides, switches are set preliminary to the multiplexing of the optical signals by the multiplexer for shutting down each channel under the control of the switch controller when the supervisory signal receiver has determined that no proper optical signal was transmitted to the channel. Consequently, a leakage signal in the channel is not to be multiplexed by the multiplexer. Thereby, it is possible to prevent the effect of coherent crosstalk noise.

In accordance with the eighth aspect of the present invention, there is provided an optical power control apparatus comprising: a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels; a supervisory signal receiver for receiving a supervisory signal indicating whether there is transmission of at least part of the optical signals of the respective channels which form the multiplexed optical signal input to the demultiplexer; signal level adjusting sections set in the channels, respectively, for adjusting the levels of the optical signals of the respective channels demultiplexed by the demultiplexer; a multiplexer for multiplexing the optical signals of the respective channels, which have passed through the signal level adjusting sections; and a signal level adjusting section controller which controls the respective signal level adjusting sections so as to attenuate the level of the optical signal of each channel to the greatest extent possible when the supervisory signal receiver has determined that no optical signal was transmitted to the channel.

That is, according to the eighth aspect of the present invention, after the demultiplexer has demultiplexed a multiplexed optical signal obtained by multiplexing optical signals with different wavelengths each corresponding to one channel, the supervisory signal receiver receives the supervisory signal indicating whether there is transmission of at least part of the optical signals of the respective channels which form the multiplexed optical signal input to the demultiplexer. Besides, signal level adjusting sections are set preliminary to the multiplexing of the optical signals by the multiplexer for attenuating the level of the optical signal of each channel to the greatest extent possible when the supervisory signal receiver has determined that no optical signal was transmitted to the channel. Consequently, a leakage signal in the channel is attenuated to the greatest extent possible. Thereby, it is possible to reduce the effect of coherent crosstalk noise.

In accordance with the ninth aspect of the present invention, in the optical power control apparatus in one of the fourth, sixth and eighth aspects, each of the signal level adjusting sections includes: a signal level adjuster capable of increasing the insertion loss to such level that an input optical signal is substantially shut off; an adjusted signal level detector for detecting the power level of the optical signal which has passed through the signal level adjuster; and a signal level adjustment controller for controlling the adjustment of signal level performed by the signal level adjuster so that the power level of each optical signal detected by the adjusted signal level detector becomes a prescribed value.

That is, according to the ninth aspect of the present invention, in the optical power control apparatus in one of the fourth, sixth and eighth aspects, each of the signal level adjusting sections substantially prevents the effect of an unwanted leakage optical signal with the use of the signal level adjuster capable of increasing the insertion loss to such level that an input optical signal is substantially shut off. In addition, the signal level adjustment controller controls the signal level adjuster so tat the output level of the optical signal of each channel can be adjusted.

In accordance with the tenth aspect of the present invention, in the optical power control apparatus in one of the fourth, sixth and eighth aspects, each of the signal level adjusting sections includes: an attenuator capable of increasing the insertion loss to such level that an input optical signal is substantially shut off, an attenuated signal level detector for detecting the power level of the optical signal which has passed through the attenuator; and an insertion loss controller for controlling the amount of the insertion loss to be increased by the attenuator so that the power level of each optical signal detected by the attenuated signal level detector becomes a prescribed value.

That is, according to the tenth aspect of the present invention, in the optical power control apparatus in one of the fourth, sixth and eighth aspects, the attenuator is used as an example of the signal level adjuster.

In accordance with the eleventh aspect of the present invention, in the optical power control apparatus in one of the third to eighth aspects, the demultiplexer and the multiplexer are formed of arrayed waveguide gratings, respectively.

That is, according to the eleventh aspect of the present invention, in the optical power control apparatus in one of the third to eighth aspects, the demultiplexer and the multiplexer are formed of arrayed waveguide gratings, and the case where crosstalk occurs between the channels of the arrayed waveguide grating is taken as an example.

In accordance with the twelfth aspect of the present invention, in the optical power control apparatus in the seventh or eighth aspect, the supervisory signal receiver is an OSC (Optical Server Channel) terminator that terminates an OSC signal.

That is, according to the twelfth aspect of the present invention, the supervisory signal receiver is implemented by the OSC (Optical Server Channel) terminator that terminates an OSC signal. Consequently, the present invention can be applied to a large number of optical optical transport systems.

In accordance with the thirteenth aspect of the present invention, the optical power control apparatus in the fourth aspect further comprises: an adjusted optical signal detector for detecting optical signals which have been adjusted by the signal level adjusting sections, respectively; and a signal level adjusting section failure finder which determines that a failure has occurred in the signal level adjusting sections when the adjusted optical signal detector has detected no optical signal after the optical signal detector detected optical signal input.

That is, according to the thirteenth aspect of the present invention, the adjusted optical signal detector detects the optical signal which has been adjusted by the signal level adjusting section, and the signal level adjusting section failure finder determines that a failure has occurred in the signal level adjusting sections when the adjusted optical signal detector has detected no optical signal after the optical signal detector detected optical signal input. With this construction, it is possible to find failures in the signal level adjusting sections such as attenuators.

In accordance with the fourteenth aspect of the present invention, there is provided an optical power control method comprising: an optical signal transmission detecting step for detecting the presence or absence of optical signals transmitted through their respective proper channels with respect to each of a plurality of channels for transmitting optical signals each having a different wavelength, respectively, to the same multiplexer, in at least part of which at least part of each optical signal leaks into a channel allocated for an optical signal having another wavelength; and a shutting down step for shutting down the channel where no proper optical signal transmission was detected at the optical signal transmission detecting step.

That is, according to the fourteenth aspect of the present invention, in the case where the optical power control apparatus is provided with the optical signal transmitting section in which at least part of an optical signal with a certain wavelength leaks into a channel for another wavelength in at least part of the channels to the same multiplexer, the presence of optical signals transmitted through their respective proper channels in the optical signal transmitting section (optical signals transmitted through the channels originally allocated for them, respectively) is detected at the optical signal transmission detecting step. Based on the detection result, the channel where no proper optical signal transmission has been detected is shut down at the shutting down step so that the optical signal which has leaked into the channel is not to be multiplexed by the multiplexer. Thereby, it is possible to prevent the effect of coherent crosstalk noise.

In accordance with the fifteenth aspect of the present invention, there is provided an optical power control method comprising: an optical signal transmission detecting step for detecting the presence or absence of optical signals transmitted through their respective proper channels with respect to each of a plurality of channels for transmitting optical signals each having a different wavelength, respectively, to the same multiplexer, in at least part of which at least part of each optical signal leaks into a channel allocated for an optical signal having another wavelength; and an insertion loss increasing step for increasing the insertion loss in the channel where no proper optical signal transmission was detected at the optical signal transmission detecting step so that the insertion loss in the channel becomes greater than the insertion loss that occurs on the occasion of proper optical signal transmission.

That is, according to the fifteenth aspect of the present invention, in the case where the optical power control apparatus is provided with the optical signal transmitting section in which at least part of an optical signal with a certain wavelength leaks into a channel for another wavelength in at least part of the channels to the same multiplexer, the presence of optical signals transmitted through their respective proper channels in the optical signal transmitting section is detected at the optical signal transmission detecting step. Besides, the insertion loss in the channel where no proper optical signal transmission has been detected is increased so as to be greater than the insertion loss that occurs on the occasion of proper optical signal transmission. Thus, the quantity of leakage signals to be multiplexed by the multiplexer is reduced, which enables a reduction in the effect of coherent crosstalk noise.

In accordance with the sixteenth aspect of the present invention, there is provided an optical power control method comprising: a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels; a demultiplexed signal level detecting step for detecting the power levels of the optical signals of the respective channels demultiplexed at the demultiplexing step; an optical signal detecting step for deciding whether or not the power level of each optical signal detected at the demultiplexed signal level detecting step is lower than the lowest level of an received optical signal to detect optical signal input with respect to each channel; a switching step for receiving the optical signals of the respective channels demultiplexed at the demultiplexing step, and blocking the passage of the optical signal of the channel where no optical signal input was detected at the optical signal detecting step; and a multiplexing step for multiplexing the optical signals of the respective channels, whose passage was allowed at the switching step.

That is, according to the sixteenth aspect of the present invention, after a multiplexed optical signal obtained by multiplexing optical signals with different wavelengths each corresponding to one channel is demultiplexed at the demultiplexing step, the power levels of the optical signals of the respective channels are detected at the demultiplexed signal level detecting step. Then, at the optical signal detecting step, it is determined whether or not the power level of each optical signal is lower than the lowest received signal level to detect optical signal input with respect to each channel. Besides, the channel where no optical signal input has been detected is shut down at the switching step preliminary to the multiplexing of the optical signals. Consequently, a leakage signal in the channel is not to be multiplexed at the multiplexing step. Thereby, it is possible to prevent the effect of coherent crosstalk noise.

In accordance with the seventeenth aspect of the present invention, there is provided an optical power control method comprising: a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels; a demultiplexed signal level detecting step for detecting the power levels of the optical signals of the respective channels demultiplexed at the demultiplexing step; an optical signal detecting step for deciding whether or not the power level of each optical signal detected at the demultiplexed signal level detecting step is lower than the lowest level of an received optical signal to detect optical signal input with respect to each channel; a signal level adjusting step for receiving the optical signals of the respective channels demultiplexed at the demultiplexing step, and adjusting the signal level so as to attenuate the level of the optical signal of the channel where no optical signal input was detected at the optical signal detecting step to the greatest extent possible; and a multiplexing step for multiplexing the optical signals of the respective channels which have undergone the signal level adjusting step.

That is, according to the seventeenth aspect of the present invention, after a multiplexed optical signal obtained by multiplexing optical signals with different wavelengths each corresponding to one channel is demultiplexed at the demultiplexing step, the power levels of the optical signals of the respective channels are detected at the demultiplexed signal level detecting step. Then, at the optical signal detecting step, it is determined whether or not the power level of each optical signal is lower than the lowest received signal level to detect optical signal input with respect to each channel. Besides, the level of the optical signal of the channel where no optical signal input has been detected is attenuated to the greatest extent possible at the signal level adjusting step preliminary to the multiplexing of the optical signals at the multiplexing step. In other words, a leakage signal in the channel is attenuated to the greatest extent possible before being multiplexed at the multiplexing step. Thereby, it is possible to reduce the effect of coherent crosstalk noise.

In accordance with the eighteenth aspect of the present invention, there is provided an optical power control method comprising: a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels; a spectrum analyzing step for analyzing the spectrum of the multiplexed optical signal before being demultiplexed at the demultiplexing step; a wavelength-specific signal level detecting step for detecting the power levels of the optical signals of the respective channels based on the analysis result obtained at the spectrum analyzing step; an optical signal detecting step for deciding whether or not the power level of the optical signal detected at the wavelength-specific signal level detecting step with respect to each wavelength is lower than the lowest level of an received optical signal to detect optical signal input in each channel; a switching step for receiving the optical signals of the respective channels demultiplexed at the demultiplexing step, and blocking the passage of the optical signal of the channel where no optical signal input was detected at the optical signal detecting step; and a multiplexing step for multiplexing the optical signals of the respective channels, whose passage was allowed at the switching step.

That is, according to the eighteenth aspect of the present invention, after a multiplexed optical signal obtained by multiplexing optical signals with different wavelengths each corresponding to one channel is demultiplexed at the demultiplexing step, the spectrum of the multiplexed optical signal before being demultiplexed at the demultiplexing step is analyzed at the spectrum analyzing step. Based on the analysis result obtained at the spectrum analyzing step, the power levels of the optical signals of the respective channels are detected at the wavelength-specific signal level detecting step. Herewith, optical signal input is detected with respect to each channel at the optical signal detecting step. Besides, the channel where no optical signal input has been detected is shut down at the switching step preliminary to the multiplexing of the optical signals. Consequently, a leakage signal in the channel is not to be multiplexed at the multiplexing step. Thereby, it is possible to prevent the effect of coherent crosstalk noise.

In accordance with the nineteenth aspect of the present invention, there is provided an optical power control method comprising: a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels; a spectrum analyzing step for analyzing the spectrum of the multiplexed optical signal before being demultiplexed at the demultiplexing step; a wavelength-specific signal level detecting step for detecting the power levels of the optical signals of the respective channels based on the analysis result obtained at the spectrum analyzing step; an optical signal detecting step for deciding whether or not the power level of the optical signal detected at the wavelength-specific signal level detecting step with respect to each wavelength is lower than the lowest level of an received optical signal to detect optical signal input in each channel; a signal level adjusting step for receiving the optical signals of the respective channels demultiplexed at the demultiplexing step, and adjusting the signal level so as to attenuate the level of the optical signal of the channel where no optical signal input was detected at the optical signal detecting step to the greatest extent possible; and a multiplexing step for multiplexing the optical signals of the respective channels which have undergone the signal level adjusting step.

That is, according to the nineteenth aspect of the present invention, after a multiplexed optical signal obtained by multiplexing optical signals with different wavelengths each corresponding to one channel is demultiplexed at the demultiplexing step, the spectrum of the multiplexed optical signal before being demultiplexed at the demultiplexing step is analyzed at the spectrum analyzing step. Based on the analysis result obtained at the spectrum analyzing step, the power levels of the optical signals of the respective channels are detected at the wavelength-specific signal level detecting step. Herewith, optical signal input is detected with respect to each channel at the optical signal detecting step. Besides, the level of the optical signal of the channel where no optical signal input has been detected is attenuated to the greatest extent possible at the signal level adjusting step preliminary to the multiplexing of the optical signals at the multiplexing step. In other words, a leakage signal in the channel is attenuated to the greatest extent possible before being multiplexed at the multiplexing step. Thereby, it is possible to reduce the effect of coherent crosstalk noise.

In accordance with the twentieth aspect of the present invention, there is provided an optical power control method comprising: a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels; a supervisory signal receiving step for receiving a supervisory signal indicating whether there is transmission of at least part of the optical signals of the respective channels which form the multiplexed optical signal input at the demultiplexing step; a switching step for receiving the optical signals of the respective channels demultiplexed at the demultiplexing step, and blocking the passage of the optical signal of the channel where no optical signal input was detected at the supervisory signal receiving step; and a multiplexing step for multiplexing the optical signals of the respective channels, whose passage was allowed at the switching step.

That is, according to the twentieth aspect of the present invention, after a multiplexed optical signal obtained by multiplexing optical signals with different wavelengths each corresponding to one channel is demultiplexed at the demultiplexing step, a supervisory signal indicating whether there is transmission of at least part of the optical signals of the respective channels which form the multiplexed optical signal input at the demultiplexing step is received at the supervisory signal receiving step. Besides, at the switching step, the optical signals of the respective channels demultiplexed at the demultiplexing step are received, and the channel where no optical signal input was detected at the supervisory signal receiving step is shut down preliminary to the multiplexing of the optical signals. Consequently, a leakage signal in the channel is not to be multiplexed at the multiplexing step. Thereby, it is possible to prevent the effect of coherent crosstalk noise.

In accordance with the twenty-first aspect of the present invention, there is provided an optical power control method comprising: a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels; a supervisory signal receiving step for receiving a supervisory signal indicating whether there is transmission of at least part of the optical signals of the respective channels which form the multiplexed optical signal input at the demultiplexing step; a signal level adjusting step for receiving the optical signals of the respective channels demultiplexed at the demultiplexing step, and adjusting the signal level so as to attenuate the level of the optical signal of the channel where no optical signal input was detected at the supervisory signal receiving step to the greatest extent possible; and a multiplexing step for multiplexing the optical signals of the respective channels which have undergone the signal level adjusting step.

That is, according to the twenty-first aspect of the present invention, after a multiplexed optical signal obtained by multiplexing optical signals with different wavelengths each corresponding to one channel is demultiplexed at the demultiplexing step, a supervisory signal indicating whether there is transmission of at least part of the optical signals of the respective channels which form the multiplexed optical signal input at the demultiplexing step is received at the supervisory signal receiving step. Besides, at the signal level adjusting step, the optical signals of the respective channels demultiplexed at the demultiplexing step are received, and the level of the optical signal of the channel where no optical signal input was detected at the supervisory signal receiving step is attenuated to the greatest extent possible preliminary to the multiplexing of the optical signals at the multiplexing step. In other words, a leakage signal in the channel is attenuated to the greatest extent possible before being multiplexed at the multiplexing step. Thereby, it is possible to reduce the effect of coherent crosstalk noise.

In accordance with the twenty-second aspect of the present invention, there is provided an optical power control method comprising: a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels; a demultiplexed signal level detecting step for detecting the power levels of the optical signals of the respective channels demultiplexed at the demultiplexing step; an optical signal detecting step for deciding whether or not the power level of each optical signal detected at the demultiplexed signal level detecting step is lower than the lowest level of an received optical signal to detect optical signal input with respect to each channel; a signal level adjusting step for adjusting the signal level so as to attenuate the level of the optical signal of the channel where no optical signal input was detected at the optical signal detecting step to the greatest extent possible; a multiplexing step for multiplexing the optical signals of the respective channels which have undergone the signal level adjusting step; an adjusted optical signal detecting step for detecting optical signals which were adjusted at the signal level adjusting step; and a signal level adjustment failure finding step for determining that a failure occurred in the adjustment carried out at the signal level adjusting step when no optical signal was detected at the adjusted optical signal detecting step after optical signal input had been detected at the optical signal detecting step.

That is, according to the twenty-second aspect of the present invention, after a multiplexed optical signal obtained by multiplexing optical signals with different wavelengths each corresponding to one channel is demultiplexed at the demultiplexing step, the power levels of the optical signals of the respective channels are detected at the demultiplexed signal level detecting step. Then, at the optical signal detecting step, it is determined whether or not the power level of each optical signal is lower than the lowest received signal level to detect optical signal input with respect to each channel. Besides, the level of the optical signal of the channel where no optical signal input has been detected is attenuated to the greatest extent possible at the signal level adjusting step preliminary to the multiplexing of the optical signals at the multiplexing step. In other words, a leakage signal in the channel is attenuated to the greatest extent possible before being multiplexed at the multiplexing step. Thereby, it is possible to reduce the effect of coherent crosstalk noise. In addition, the optical signal which was adjusted at the signal level adjusting step is detected at the adjusted optical signal detecting step, and at the signal level adjustment failure finding step, it is determined that a failure occurred in the adjustment carried out at the signal level adjusting step when no optical signal was detected at the adjusted optical signal detecting step after optical signal input had been detected at the optical signal detecting step. With this construction, it is possible to find failures in the circuit components for adjusting the signal level such as attenuators.

In accordance with the twenty-third aspect of the present invention, there is provided an optical power control program for controlling a computer to perform: an optical signal transmission detecting process for detecting the presence or absence of optical signals transmitted through their respective proper channels with respect to each of a plurality of channels for transmitting optical signals each having a different wavelength, respectively, to the same multiplexer, in at least part of which at least part of each optical signal leaks into a channel allocated for an optical signal having another wavelength; and a shutting down process for shutting down the channel where no proper optical signal transmission has been detected by the optical signal transmission detecting process.

That is, according to the twenty-third aspect of the present invention, in the case where the optical power control apparatus is provided with the optical signal transmitting section in which at least part of an optical signal with a certain wavelength leaks into a channel for another wavelength in at least part of the channels to the same multiplexer, the optical power control program causes the computer to detect the presence of optical signals transmitted through their respective proper channels in the optical signal transmitting section by the optical signal transmission detecting process. Based on the detection result, the channel where no proper optical signal transmission has been detected is shut down by the shutting down process so that the optical signal which has leaked into the channel is not to be multiplexed by the multiplexer. Thereby, it is possible to prevent the effect of coherent crosstalk noise.

In accordance with the twenty-fourth aspect of the present invention, there is provided an optical power control program for controlling a computer to perform: an optical signal transmission detecting process for detecting the presence or absence of optical signals transmitted through their respective proper channels with respect to each of a plurality of channels for transmitting optical signals each having a different wavelength, respectively, to the same multiplexer, in at least part of which at least part of each optical signal leaks into a channel allocated for an optical signal having another wavelength; and an insertion loss increasing process for increasing the insertion loss in the channel where no proper optical signal transmission has been detected by the optical signal transmission detecting process so that the insertion loss in the channel becomes greater than the insertion loss that occurs on the occasion of proper optical signal transmission.

That is, according to the twenty-fourth aspect of the present invention, in the case where the optical power control apparatus is provided with the optical signal transmitting section in which at least part of an optical signal with a certain wavelength leaks into a channel for another wavelength in at least part of the channels to the same multiplexer, the optical power control program causes the computer to detect the presence of optical signals transmitted through their respective proper channels in the optical signal transmitting section by the optical signal transmission detecting process. Besides, the insertion loss in the channel where no proper optical signal transmission has been detected is increased so as to be greater than the insertion loss that occurs on the occasion of proper optical signal transmission. Thus, the quantity of leakage signals to be multiplexed by the multiplexer is reduced, which enables a reduction in the effect of coherent crosstalk noise.

In accordance with the twenty-fifth aspect of the present invention, there is provided an optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform: a demultiplexed signal level detecting process for detecting the power levels of the optical signals of the respective channels demultiplexed by the demultiplexer; an optical signal detecting process for deciding whether or not the power level of each optical signal detected by the demultiplexed signal level detecting process is lower than the lowest level of an received optical signal to detect optical signal input with respect to each channel; and a switching process for receiving the optical signals of the respective channels demultiplexed by the demultiplexing process, and preventing the optical signal of the channel where no optical signal input has been detected by the optical signal detecting process from being input in the multiplexer.

That is, according to the twenty-fifth aspect of the present invention, the optical power control program is applied to the computer of an intermediary device comprising the demultiplexer which receives a multiplexed optical signal obtained by multiplexing optical signals having different wavelengths each corresponding to one channel to demultiplex the multiplexed optical signal, and the multiplexer which receives the optical signals of the respective channels demultiplexed by the demultiplexer to multiplex the optical signals after their power levels have been adjusted, respectively. Under program control, the power levels of the optical signals of the respective channels demultiplexed by the demultiplexer are detected by the demultiplexed signal level detecting process. Then, by the optical signal detecting process, it is determined whether or not the power level of each optical signal is lower than the lowest received signal level to detect optical signal input with respect to each channel. Besides, the channel where no optical signal input has been detected is shut down by the switching process to prevent the optical signal in the channel from being input to the multiplexer. Consequently, a leakage signal in the channel is not to be multiplexed by the multiplexer. Thereby, it is possible to prevent the effect of coherent crosstalk noise.

In accordance with the twenty-sixth aspect of the present invention, there is provided an optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform: a demultiplexed signal level detecting process for detecting the power levels of the optical signals of the respective channels demultiplexed by the demultiplexer; an optical signal detecting process for deciding whether or not the power level of each optical signal detected by the demultiplexed signal level detecting process is lower than the lowest level of an received optical signal to detect optical signal input with respect to each channel; and a signal level adjusting process for adjusting the signal level so as to attenuate the level of the optical signal of the channel where no optical signal input has been detected by the optical signal detecting process to the greatest extent possible before inputting the optical signal in the multiplexer.

That is, according to the twenty-sixth aspect of the present invention, the optical power control program is applied to the computer of an intermediary device comprising the demultiplexer which receives a multiplexed optical signal obtained by multiplexing optical signals having different wavelengths each corresponding to one channel to demultiplex the multiplexed optical signal, and the multiplexer which receives the optical signals of the respective channels demultiplexed by the demultiplexer to multiplex the optical signals after their power levels have been adjusted, respectively. Under program control, the power levels of the optical signals of the respective channels demultiplexed by the demultiplexer are detected by the demultiplexed signal level detecting process. Then, by the optical signal detecting process, it is determined whether or not the power level of each optical signal is lower than the lowest received signal level to detect optical signal input with respect to each channel. Besides, the level of the optical signal of the channel where no optical signal input has been detected is attenuated to the greatest extent possible by the signal level adjusting process preliminary to the multiplexing of the optical signals by the multiplexer. In other words, a leakage signal in the channel is attenuated to the greatest extent possible before being multiplexed by the multiplexer. Thereby, it is possible to reduce the effect of coherent crosstalk noise.

In accordance with the twenty-seventh aspect of the present invention, there is provided an optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform: a spectrum analyzing process for analyzing the spectrum of the multiplexed optical signal before being demultiplexed by the demultiplexer; a wavelength-specific signal level detecting process for detecting the power levels of the optical signals of the respective channels based on the analysis result obtained by the spectrum analyzing process; an optical signal detecting process for deciding whether or not the power level of the optical signal detected by the wavelength-specific signal level detecting process with respect to each wavelength is lower than the lowest level of an received optical signal to detect optical signal input in each channel; and a switching process for receiving the optical signals of the respective channels demultiplexed by the demultiplexer, and preventing the optical signal of the channel where no optical signal input has been detected by the optical signal detecting process from being input in the multiplexer.

That is, according to the twenty-seventh aspect of the present invention, the optical power control program is applied to the computer of an intermediary device comprising the demultiplexer which receives a multiplexed optical signal obtained by multiplexing optical signals having different wavelengths each corresponding to one channel to demultiplex the multiplexed optical signal, and the multiplexer which receives the optical signals of the respective channels demultiplexed by the demultiplexer to multiplex the optical signals after their power levels have been adjusted, respectively. Under program control, the spectrum of the multiplexed optical signal before being demultiplexed by the demultiplexer is analyzed by the spectrum analyzing process. Based on the analysis result obtained by the spectrum analyzing process, the power levels of the optical signals of the respective channels are detected by the wavelength-specific signal level detecting process. Herewith, optical signal input is detected with respect to each channel by the optical signal detecting process. Besides, the channel where no optical signal input has been detected is shut down by the switching process to prevent the optical signal in the channel from being input to the multiplexer. Consequently, a leakage signal in the channel is not to be multiplexed by the multiplexer. Thereby, it is possible to prevent the effect of coherent crosstalk noise.

In accordance with the twenty-eighth aspect of the present invention, there is provided an optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform: a spectrum analyzing process for analyzing the spectrum of the multiplexed optical signal before being demultiplexed by the demultiplexer; a wavelength-specific signal level detecting process for detecting the power levels of the optical signals of the respective channels based on the analysis result obtained by the spectrum analyzing process; an optical signal detecting process for deciding whether or not the power level of the optical signal detected by the wavelength-specific signal level detecting process with respect to each wavelength is lower than the lowest level of an received optical signal to detect optical signal input in each channel; and a signal level adjusting process for adjusting the signal level so as to attenuate the level of the optical signal of the channel where no optical signal input has been detected by the optical signal detecting process to the greatest extent possible before inputting the optical signal in the multiplexer.

That is, according to the twenty-eighth aspect of the present invention, the optical power control program is applied to the computer of an intermediary device comprising the demultiplexer which receives a multiplexed optical signal obtained by multiplexing optical signals having different wavelengths each corresponding to one channel to demultiplex the multiplexed optical signal, and the multiplexer which receives the optical signals of the respective channels demultiplexed by the demultiplexer to multiplex the optical signals after their power levels have been adjusted, respectively. Under program control, the spectrum of the multiplexed optical signal before being demultiplexed by the demultiplexer is analyzed by the spectrum analyzing process. Based on the analysis result obtained by the spectrum analyzing process, the power levels of the optical signals of the respective channels are detected by the wavelength-specific signal level detecting process. Herewith, optical signal input is detected with respect to each channel by the optical signal detecting process. Besides, the level of the optical signal of the channel where no optical signal input has been detected is attenuated to the greatest extent possible by the signal level adjusting process preliminary to the multiplexing of the optical signals by the multiplexer. In other words, a leakage signal in the channel is attenuated to the greatest extent possible before being multiplexed by the multiplexer. Thereby, it is possible to reduce the effect of coherent crosstalk noise.

In accordance with the twenty-ninth aspect of the present invention, there is provided an optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform: a supervisory signal receiving process for receiving a supervisory signal indicating whether there is transmission of at least part of the optical signals of the respective channels which form the multiplexed optical signal input to the demultiplexer; and a switching process for preventing the optical signal of each channel from being input in the multiplexer when it has been determined that no optical signal was transmitted to the channel by the supervisory signal receiving process.

That is, according to the twenty-ninth aspect of the present invention, the optical power control program is applied to the computer of an intermediary device comprising the demultiplexer which receives a multiplexed optical signal obtained by multiplexing optical signals having different wavelengths each corresponding to one channel to demultiplex the multiplexed optical signal, and the multiplexer which receives the optical signals of the respective channels demultiplexed by the demultiplexer to multiplex the optical signals after their power levels have been adjusted, respectively. Under program control, a supervisory signal indicating whether there is transmission of at least part of the optical signals of the respective channels which form the multiplexed optical signal input to the demultiplexer is received by the supervisory signal receiving process. Besides, by the switching process, the optical signal of each channel is prevented from being input in the multiplexer when it has been determined that no optical signal was transmitted to the channel by the supervisory signal receiving process. Consequently, a leakage signal in the channel is not to be multiplexed by the multiplexer. Thereby, it is possible to prevent the effect of coherent crosstalk noise.

In accordance with the thirtieth aspect of the present invention, there is provided an optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform: a supervisory signal receiving process for receiving a supervisory signal indicating whether there is transmission of at least part of the optical signals of the respective channels which form the multiplexed optical signal input to the demultiplexer; and a signal level adjusting process for adjusting the signal level so as to attenuate the level of the optical signal of each channel to the greatest extent possible when it has been determined that no optical signal was transmitted to the channel by the supervisory signal receiving process.

That is, according to the thirtieth aspect of the present invention, the optical power control program is applied to the computer of an intermediary device comprising a demultiplexer which receives a multiplexed optical signal obtained by multiplexing optical signals having different wavelengths each corresponding to one channel to demultiplex the multiplexed optical signal, and a multiplexer which receives the optical signals of the respective channels demultiplexed by the demultiplexer to multiplex the optical signals after their power levels have been adjusted, respectively. Under program control, a supervisory signal indicating whether there is transmission of at least part of the optical signals of the respective channels which form the multiplexed optical signal input to the demultiplexer is received by the supervisory signal receiving process. Besides, by the signal level adjusting process, the level of the optical signal of each channel is attenuated to the greatest extent possible when it has been determined that no optical signal was transmitted to the channel by the supervisory signal receiving process. In other words, a leakage signal in the channel is attenuated to the greatest extent possible before being multiplexed by the multiplexer. Thereby, it is possible to reduce the effect of coherent crosstalk noise.

In accordance with the thirty-first aspect of the present invention, there is provided an optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform: a demultiplexed signal level detecting process for detecting the power levels of the optical signals of the respective channels demultiplexed by the demultiplexer; an optical signal detecting process for deciding whether or not the power level of each optical signal detected by the demultiplexed signal level detecting process is lower than the lowest level of an received optical signal to detect optical signal input with respect to each channel; a signal level adjusting process for adjusting the signal level so as to attenuate the level of the optical signal of the channel where no optical signal input has been detected by the optical signal detecting process to the greatest extent possible; an adjusted optical signal detecting process for detecting optical signals which were adjusted by the signal level adjusting process; and a signal level adjustment failure finding process for determining that a failure occurred in the adjustment carried out by the signal level adjusting process when no optical signal was detected by the adjusted optical signal detecting process after optical signal input had been detected by the optical signal detecting process.

That is, according to the thirty-first aspect of the present invention, the optical power control program is applied to the computer of an intermediary device comprising the demultiplexer which receives a multiplexed optical signal obtained by multiplexing optical signals having different wavelengths each corresponding to one channel to demultiplex the multiplexed optical signal, and the multiplexer which receives the optical signals of the respective channels demultiplexed by the demultiplexer to multiplex the optical signals after their power levels have been adjusted, respectively. Under program control, the power levels of the demultiplexed optical signals of the respective channels are detected by the demultiplexed signal level detecting process. Then, by the optical signal detecting process, it is determined whether or not the power level of each optical signal detected by the demultiplexed signal level detecting process is lower than the lowest received signal level to detect optical signal input with respect to each channel. Besides, the level of the optical signal of the channel where no optical signal input has been detected is attenuated to the greatest extent possible by the signal level adjusting process preliminary to the multiplexing of the optical signals by the multiplexer. In other words, a leakage signal in the channel is attenuated to the greatest extent possible before being multiplexed by the multiplexer. Thereby, it is possible to reduce the effect of coherent crosstalk noise. In addition, the optical signal which was adjusted by the signal level adjusting process is detected by the adjusted optical signal detecting process, and by the signal level adjustment failure finding process, it is determined that a failure occurred in the adjustment carried out by the signal level adjusting process when no optical signal was detected by the adjusted optical signal detecting process after optical signal input had been detected by the optical signal detecting process. With this construction, it is possible to find failures in the circuit components for adjusting the signal level such as attenuators.

As set forth hereinabove, in accordance with one aspect of the present invention, regardless of types of plural channels to a multiplexer, in the case where the channels have characteristics such that at least a part of an optical signal with a certain wavelength leaks into a channel for another wavelength in at least part of the channels, the effect of coherent crosstalk noise can be prevented by shutting down the channel where no optical signal has been transmitted. Thus, it is possible to improve the quality of optical signals in a variety of devices as well as in intermediary devices.

In accordance with another aspect of the present invention, regardless of types of plural channels to a multiplexer, in the case where the channels have characteristics such that at least a part of an optical signal with a certain wavelength leaks into a channel for another wavelength in at least part of the channels, the insertion loss in the channel where no optical signal has been transmitted is increased by using an attenuator so that the insertion loss in the channel becomes greater than the insertion loss that occurs when transmitting a proper optical signal. With this construction, the effect of coherent crosstalk noise can be reduced. Thus, it is possible to improve the quality of optical signals in a variety of devices as well as in intermediary devices.

In accordance with another aspect of the present invention, after a multiplexed optical signal has demultiplexed into optical signals with different wavelengths each corresponding to one channel, the power levels of the optical signals of the respective channels are detected. When it is determined that no proper optical signal has been input to a channel based on the detection result, the channel is shut off. With this construction, the effect of coherent crosstalk noise can be prevented. Thus, it is possible to improve the quality of optical signals in a variety of devices as well as in intermediary devices.

In accordance with another aspect of the present invention, after a multiplexed optical signal has demultiplexed into optical signals with different wavelengths each corresponding to one channel, the power levels of the optical signals of the respective channels are detected. When it is determined that no proper optical signal has been input to a channel based on the detection result, the level of an optical signal in the channel is adjusted, that is, attenuated to the greatest extent possible. With this construction, the effect of coherent crosstalk noise can be reduced. Thus, it is possible to improve the quality of optical signals in a variety of devices as well as in intermediary devices.

In accordance with another aspect of the present invention, the spectrum of a multiplexed optical signal is analyzed. When it is determined that no proper optical signal has been input to a channel based on the analysis result, the channel is shut off. With this construction, the effect of coherent crosstalk noise can be prevented. Thus, it is possible to improve the quality of optical signals in a variety of devices as well as in intermediary devices. In addition, if the spectrum analysis is carried out with the use of a spectrum analyzer, there is no need to detect the power levels of the optical signals of the respective channels after demultiplexing a multiplexed optical signal. Thereby, the use of photo acceptance units such as photodiodes is not required.

In accordance with another aspect of the present invention, the spectrum of a multiplexed optical signal is analyzed. When it is determined that no proper optical signal has been input to a channel based on the analysis result, the level of an optical signal in the channel is adjusted, that is, attenuated to the greatest extent possible. With this construction, the effect of coherent crosstalk noise can be reduced. Thus, it is possible to improve the quality of optical signals in a variety of devices as well as in intermediary devices. In addition, if the spectrum analysis is carried out with the use of a spectrum analyzer, there is no need to detect the power levels of the optical signals of the respective channels after demultiplexing a multiplexed optical signal. Thereby, the use of photo acceptance units such as photodiodes is not required.

In accordance with another aspect of the present invention, a supervisory signal indicating whether there is transmission of at least part of the optical signals of the respective channels is received. When it is determined that no proper optical signal has been input to a channel based on the supervisory signal, the channel is shut off. With this construction, the effect of coherent crosstalk noise can be prevented. Thus, it is possible to improve the quality of optical signals in a variety of devices as well as in intermediary devices. Moreover, in the environment where such supervisory signal can be received, there is no need to detect the power levels of the optical signals of the respective channels after demultiplexing a multiplexed optical signal. Thereby, the use of photo acceptance units such as photodiodes is not required.

In accordance with yet another aspect of the present invention, a supervisory signal indicating whether there is transmission of at least part of the optical signals of the respective channels is received. When it is determined that no proper optical signal has been input to a channel based on the supervisory signal, the level of an optical signal in the channel is adjusted, that is, attenuated to the greatest extent possible. With this construction, the effect of coherent crosstalk noise can be reduced. Thus, it is possible to improve the quality of optical signals in a variety of devices as well as in intermediary devices. Moreover, in the environment where such supervisory signal can be received, there is no need to detect the power levels of the optical signals of the respective channels after demultiplexing a multiplexed optical signal. Thereby, the use of photo acceptance units such as photodiodes is not required.

In accordance with yet another aspect of the present invention, it is determined that a failure or an error has occurred when an optical signal whose power level has been adjusted is not detected after optical signal input was detected. With this construction, it is possible to overcome a failure in a device such as an intermediary device early on.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An optical power control apparatus comprising:
a multiplexer for multiplexing two or more optical signals having different wavelengths;
an optical signal transmitting section including a plurality of channels for transmitting optical signals each having a different wavelength, respectively, to the multiplexer, which allows at least part of each optical signal to leak into a channel for an optical signal having another wavelength in at least part of the channels;
an optical signal transmission detector for detecting the presence or absence of optical signals transmitted through their respective proper channels included in the optical signal transmitting section; and
switches set in the channels of the optical signal transmitting section, respectively, for shutting down the channel where no optical signal transmission has been detected by the optical signal transmission detector.

2. An optical power control apparatus comprising:
a multiplexer for multiplexing two or more optical signals having different wavelengths;
an optical signal transmitting section including a plurality of channels for transmitting optical signals each having a different wavelength, respectively, to the multiplexer, which allows at least part of each optical signal to leak into a channel for an optical signal having another wavelength in at least part of the channels;
an optical signal transmission detector for detecting the presence or absence of optical signals transmitted through their respective proper channels in the optical signal transmitting section; and
attenuators set in the channels of the optical signal transmitting section, respectively, for increasing the insertion loss in the channel where no optical signal transmission has been detected by the optical signal transmission detector so that the insertion loss in the channel becomes greater than the insertion loss that occurs when transmitting a proper optical signal.

3. An optical power control apparatus comprising:
a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels;
demultiplexed signal level detectors set in the channels, respectively, for detecting the power levels of the optical signals;
an optical signal detector for deciding whether or not the power level of each optical signal detected by the demultiplexed signal level detector set in each channel is lower than the lowest level of an received optical signal to detect optical signal input with respect to each channel;
switches set in the channels, respectively, for passing or stopping the input optical signals of the respective channels demultiplexed by the demultiplexer;
a multiplexer for multiplexing the optical signals of the respective channels, which have passed through the switches; and
a switch controller which controls the respective switches so as to shut down the channel where no optical signal input has been detected by the optical signal detector.

4. An optical power control apparatus comprising:
a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels;
demultiplexed signal level detectors set in the channels, respectively, for detecting the power levels of the optical signals;
an optical signal detector for deciding whether or not the power level of each optical signal detected by the demultiplexed signal level detector set in each channel is lower than the lowest level of an received optical signal to detect optical signal input with respect to each channel;
signal level adjusting sections set in the channels, respectively, for adjusting the levels of the optical signals of the respective channels demultiplexed by the demultiplexer;
a multiplexer for multiplexing the optical signals of the respective channels, which have passed through the signal level adjusting sections; and
a signal level adjusting section controller which controls the respective signal level adjusting sections so as to attenuate the level of the optical signal of the channel where no optical signal input has been detected by the optical signal detector to the greatest extent possible.

5. An optical power control apparatus comprising:
a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels;
a spectrum analyzer for analyzing the spectrum of the multiplexed optical signal before being demultiplexed by the demultiplexer;
a wavelength-specific signal level detector for detecting the power levels of the optical signals of the respective channels based on the analysis result obtained by the spectrum analyzer;
an optical signal detector for deciding whether or not the power level of the optical signal detected by the wavelength-specific signal level detector with respect to each wavelength is lower than the lowest level of an received optical signal to detect optical signal input in each-channel;
switches set in the channels, respectively, for passing or stopping the input optical signals of the respective channels demultiplexed by the demultiplexer;
a multiplexer for multiplexing the optical signals of the respective channels, which have passed through the switches; and
a switch controller which controls the respective switches so as to shut down the channel where no optical signal input has been detected by the optical signal detector.

6. An optical power control apparatus comprising:
a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels;
a spectrum analyzer for analyzing the spectrum of the multiplexed optical signal before being demultiplexed by the demultiplexer;
a wavelength-specific signal level detector for detecting the power levels of the optical signals of the respective channels based on the analysis result obtained by the spectrum analyzer;
an optical signal detector for deciding whether or not the power level of the optical signal detected by the wavelength-specific signal level detector with respect to each wavelength is lower than the lowest level of an received optical signal to detect optical signal input in each channel;
signal level adjusting sections set in the channels, respectively, for adjusting the levels of the optical signals of the respective channels demultiplexed by the demultiplexer;
a multiplexer for multiplexing the optical signals of the respective channels, which have passed through the signal level adjusting sections; and
a signal level adjusting section controller which controls the respective signal level adjusting sections so as to attenuate the level of the optical signal of the channel where no optical signal input has been detected by the optical signal detector to the greatest extent possible.

7. An optical power control apparatus comprising:
a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels;
a supervisory signal receiver for receiving a supervisory signal indicating whether there is transmission of at least part of the optical signals of the respective channels which form the multiplexed optical signal input to the demultiplexer;
switches set in the channels, respectively, for passing or stopping the input optical signals of the respective channels demultiplexed by the demultiplexer;
a multiplexer for multiplexing the optical signals of the respective channels, which have passed through the switches; and
a switch controller which controls the respective switches so as to shut down each channel when the supervisory signal receiver has determined that no optical signal was transmitted to the channel.

8. An optical power control apparatus comprising:
a demultiplexer which receives a multiplexed optical signal obtained by multiplexing optical signals having different wavelengths, one channel being allocated for each, and demultiplexes the multiplexed optical signal into the optical signals having different wavelengths corresponding to the respective channels;
a supervisory signal receiver for receiving a supervisory signal indicating whether there is transmission of at least part of the optical signals of the respective channels which form the multiplexed optical signal input to the demultiplexer;
signal level adjusting sections set in the channels, respectively, for adjusting the levels of the optical signals of the respective channels demultiplexed by the demultiplexer;
a multiplexer for multiplexing the optical signals of the respective channels, which have passed through the signal level adjusting sections; and
a signal level adjusting section controller which controls the respective signal level adjusting sections so as to attenuate the level of the optical signal of each channel to the greatest extent possible when the supervisory signal receiver has determined that no optical signal was transmitted to the channel.

9. The optical power control apparatus claimed in claim 4, wherein each of the signal level adjusting sections includes:
a signal level adjuster capable of increasing the insertion loss to such level that an input optical signal is substantially shut off,
an adjusted signal level detector for detecting the power level of the optical signal which has passed through the signal level adjuster; and
a signal level adjustment controller for controlling the adjustment of signal level performed by the signal level adjuster so that the power level of each optical signal detected by the adjusted signal level detector becomes a prescribed value.

10. The optical power control apparatus claimed in claim 6, wherein each of the signal level adjusting sections includes:
a signal level adjuster capable of increasing the insertion loss to such level that an input optical signal is substantially shut off;
an adjusted signal level detector for detecting the power level of the optical signal which has passed through the signal level adjuster; and
a signal level adjustment controller for controlling the adjustment of signal level performed by the signal level adjuster so that the power level of each optical signal detected by the adjusted signal level detector becomes a prescribed value.

11. The optical power control apparatus claimed in claim 8, wherein each of the signal level adjusting sections includes:
a signal level adjuster capable of increasing the insertion loss to such level that an input optical signal is substantially shut off;
an adjusted signal level detector for detecting the power level of the optical signal which has passed through the signal level adjuster; and
a signal level adjustment controller for controlling the adjustment of signal level performed by the signal level adjuster so that the power level of each optical signal detected by the adjusted signal level detector becomes a prescribed value.

12. The optical power control apparatus claimed in claim 4, wherein each of the signal level adjusting sections includes:
an attenuator capable of increasing the insertion loss to such level that an input optical signal is substantially shut off;
an attenuated signal level detector for detecting the power level of the optical signal which has passed through the attenuator; and
an insertion loss controller for controlling the amount of the insertion loss to be increased by the attenuator so that the power level of each optical signal detected by the attenuated signal level detector becomes a prescribed value.

13. The optical power control apparatus claimed in claim 6, wherein each of the signal level adjusting sections includes:
an attenuator capable of increasing the insertion loss to such level that an input optical signal is substantially shut off;
an attenuated signal level detector for detecting the power level of the optical signal which has passed through the attenuator; and
an insertion loss controller for controlling the amount of the insertion loss to be increased by the attenuator so that the power level of each optical signal detected by the attenuated signal level detector becomes a prescribed value.

14. The optical power control apparatus claimed in claim 8, wherein each of the signal level adjusting sections includes:
an attenuator capable of increasing the insertion loss to such level that an input optical signal is substantially shut off;
an attenuated signal level detector for detecting the power level of the optical signal which has passed through the attenuator; and
an insertion loss controller for controlling the amount of the insertion loss to be increased by the attenuator so that the power level of each optical signal detected by the attenuated signal level detector becomes a prescribed value.

15. The optical power control apparatus claimed in claim 3, wherein the demultiplexer and the multiplexer are formed of arrayed waveguide gratings, respectively.

16. The optical power control apparatus claimed in claim 4, wherein the demultiplexer and the multiplexer are formed of arrayed waveguide gratings, respectively.

17. The optical power control apparatus claimed in claim 5, wherein the demultiplexer and the multiplexer are formed of arrayed waveguide gratings, respectively.

18. The optical power control apparatus claimed in claim 6, wherein the demultiplexer and the multiplexer are formed of arrayed waveguide gratings, respectively.

19. The optical power control apparatus claimed in claim 7, wherein the demultiplexer and the multiplexer are formed of arrayed waveguide gratings, respectively.

20. The optical power control apparatus claimed in claim 8, wherein the demultiplexer and the multiplexer are formed of arrayed waveguide gratings, respectively.

21. The optical power control apparatus claimed in claim 7, wherein the supervisory signal receiver is an OSC (Optical Server Channel) terminator that terminates an OSC signal.

22. The optical power control apparatus claimed in claim 8, wherein the supervisory signal receiver is an OSC (Optical Server Channel) terminator that terminates an OSC signal.

23. The optical power control apparatus claimed in claim 4 further comprising:
an adjusted optical signal detector for detecting optical signals which have been adjusted by the signal level adjusting sections, respectively; and
a signal level adjusting section failure finder which determines that a failure has occurred in the signal level adjusting sections when the adjusted optical signal detector has detected no optical signal after the optical signal detector detected optical signal input.

24. An optical power control method comprising:
an optical signal transmission detecting step for detecting the presence or absence of optical signals transmitted through their respective proper channels with respect to each of a plurality of channels for transmitting optical signals each having a different wavelength, respectively, to the same multiplexer, in at least part of which at least part of each optical signal leaks into a channel allocated for an optical signal having another wavelength; and
a shutting down step for shutting down the channel where no proper optical signal transmission was detected at the optical signal transmission detecting step.

25. An optical power control method comprising:
an optical signal transmission detecting step for detecting the presence or absence of optical signals transmitted through their respective proper channels with respect to each of a plurality of channels for transmitting optical signals each having a different wavelength, respectively, to the same multiplexer, in at least part of which at least part of each optical signal leaks into a channel allocated for an optical signal having another wavelength; and
an insertion loss increasing step for increasing the insertion loss in the channel where no proper optical signal transmission was detected at the optical signal transmission detecting step so that the insertion loss in the channel becomes greater than the insertion loss that occurs on the occasion of proper optical signal transmission.

26. An optical power control method comprising:
a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels;
a demultiplexed signal level detecting step for detecting the power levels of the optical signals of the respective channels demultiplexed at the demultiplexing step;
an optical signal detecting step for deciding whether or not the power level of each optical signal detected at the demultiplexed signal level detecting step is lower than the lowest level of an received optical signal to detect optical signal input with respect to each channel;
a switching step for receiving the optical signals of the respective channels demultiplexed at the demultiplexing step, and blocking the passage of the optical signal of the channel where no optical signal input was detected at the optical signal detecting step; and
a multiplexing step for multiplexing the optical signals of the respective channels, whose passage was allowed at the switching step.

27. An optical power control method comprising:
a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels;
a demultiplexed signal level detecting step for detecting the power levels of the optical signals of the respective channels demultiplexed at the demultiplexing step;
an optical signal detecting step for deciding whether or not the power level of each optical signal detected at the demultiplexed signal level detecting step is lower than the lowest level of an received optical signal to detect optical signal input with respect to each channel;
a signal level adjusting step for receiving the optical signals of the respective channels demultiplexed at the demultiplexing step, and adjusting the signal level so as to attenuate the level of the optical signal of the channel where no optical signal input was detected at the optical signal detecting step to the greatest extent possible; and
a multiplexing step for multiplexing the optical signals of the respective channels which have undergone the signal level adjusting step.

28. An optical power control method comprising:
a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels;
a spectrum analyzing step for analyzing the spectrum of the multiplexed optical signal before being demultiplexed at the demultiplexing step;
a wavelength-specific signal level detecting step for detecting the power levels of the optical signals of the respective channels based on the analysis result obtained at the spectrum analyzing step;
an optical signal detecting step for deciding whether or not the power level of the optical signal detected at the wavelength-specific signal level detecting step with respect to each wavelength is lower than the lowest level of an received optical signal to detect optical signal input in each channel;
a switching step for receiving the optical signals of the respective channels demultiplexed at the demultiplexing step, and blocking the passage of the optical signal of the channel where no optical signal input was detected at the optical signal detecting step; and
a multiplexing step for multiplexing the optical signals of the respective channels, whose passage was allowed at the switching step.

29. An optical power control method comprising:
a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels;
a spectrum analyzing step for analyzing the spectrum of the multiplexed optical signal before being demultiplexed at the demultiplexing step;
a wavelength-specific signal level detecting step for detecting the power levels of the optical signals of the respective channels based on the analysis result obtained at the spectrum analyzing step;
an optical signal detecting step for deciding whether or not the power level of the optical signal detected at the wavelength-specific signal level detecting step with respect to each wavelength is lower than the lowest level of an received optical signal to detect optical signal input in each channel;
a signal level adjusting step for receiving the optical signals of the respective channels demultiplexed at the demultiplexing step, and adjusting the signal level so as to attenuate the level of the optical signal of the channel where no optical signal input was detected at the optical signal detecting step to the greatest extent possible; and
a multiplexing step for multiplexing the optical signals of the respective channels which have undergone the signal level adjusting step.

30. An optical power control method comprising:
a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels;
a supervisory signal receiving step for receiving a supervisory signal indicating whether there is transmission of at least part of the optical signals of the respective channels which form the multiplexed optical signal input at the demultiplexing step;
a switching step for receiving the optical signals of the respective channels demultiplexed at the demultiplexing step, and blocking the passage of the optical signal of the channel where no optical signal input was detected at the supervisory signal receiving step; and
a multiplexing step for multiplexing the optical signals of the respective channels, whose passage was allowed at the switching step.

31. An optical power control method comprising:
a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels;
a supervisory signal receiving step for receiving a supervisory signal indicating whether there is transmission of at least part of the optical signals of the respective channels which form the multiplexed optical signal input at the demultiplexing step;
a signal level adjusting step for receiving the optical signals of the respective channels demultiplexed at the demultiplexing step, and adjusting the signal level so as to attenuate the level of the optical signal of the channel where no optical signal input was detected at the supervisory signal receiving step to the greatest extent possible; and
a multiplexing step for multiplexing the optical signals of the respective channels which have undergone the signal level adjusting step.

32. An optical power control method comprising:
a demultiplexing step for receiving a multiplexed optical signal obtained by multiplexing optical signals having different wavelengths, one channel being allocated for each, and demultiplexing the multiplexed optical signal into the optical signals having different wavelengths corresponding to the respective channels;
a demultiplexed signal level detecting step for detecting the power levels of the optical signals of the respective channels demultiplexed at the demultiplexing step;
an optical signal detecting step for deciding whether or not the power level of each optical signal detected at the demultiplexed signal level detecting step is lower than the lowest level of an received optical signal to detect optical signal input with respect to each channel;
a signal level adjusting step for adjusting the signal level so as to attenuate the level of the optical signal of the channel where no optical signal input was detected at the optical signal detecting step to the greatest extent possible;
a multiplexing step for multiplexing the optical signals of the respective channels which have undergone the signal level adjusting step;
an adjusted optical signal detecting step for detecting optical signals which were adjusted at the signal level adjusting step; and
a signal level adjustment failure finding step for determining that a failure occurred in the adjustment carried out at the signal level adjusting step when no optical signal was detected at the adjusted optical signal detecting step after optical signal input had been detected at the optical signal detecting step.

33. An optical power control program for controlling a computer to perform:
an optical signal transmission detecting process for detecting the presence or absence of optical signals transmitted through their respective proper channels with respect to each of a plurality of channels for transmitting optical signals each having a different wavelength, respectively, to the same multiplexer, in at least part of which at least part of each optical signal leaks into a channel allocated for an optical signal having another wavelength; and
a shutting down process for shutting down the channel where no proper optical signal transmission has been detected by the optical signal transmission detecting process.

34. An optical power control program for controlling a computer to perform:
an optical signal transmission detecting process for detecting the presence or absence of optical signals transmitted through their respective proper channels with respect to each of a plurality of channels for transmitting optical signals each having a different wavelength, respectively, to the same multiplexer, in at least part of which at least part of each optical signal leaks into a channel allocated for an optical signal having another wavelength; and
an insertion loss increasing process for increasing the insertion loss in the channel where no proper optical signal transmission has been detected by the optical signal transmission detecting process so that the insertion loss in the channel becomes greater than the insertion loss that occurs on the occasion of proper optical signal transmission.

35. An optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform:
a demultiplexed signal level detecting process for detecting the power levels of the optical signals of the respective channels demultiplexed by the demultiplexer;
an optical signal detecting process for deciding whether or not the power level of each optical signal detected by the demultiplexed signal level detecting process is lower than the lowest level of an received optical signal to detect optical signal input with respect to each channel; and
a switching process for receiving the optical signals of the respective channels demultiplexed by the demultiplexing process, and preventing the optical signal of the channel where no optical signal input has been detected by the optical signal detecting process from being input in the multiplexer.

36. An optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform:
a demultiplexed signal level detecting process for detecting the power levels of the optical signals of the respective channels demultiplexed by the demultiplexer;
an optical signal detecting process for deciding whether or not the power level of each optical signal detected by the demultiplexed signal level detecting process is lower than the lowest level of an received optical signal to detect optical signal input with respect to each channel; and
a signal level adjusting process for adjusting the signal level so as to attenuate the level of the optical signal of the channel where no optical signal input has been detected by the optical signal detecting process to the greatest extent possible before inputting the optical signal in the multiplexer.

37. An optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform:
a spectrum analyzing process for analyzing the spectrum of the multiplexed optical signal before being demultiplexed by the demultiplexer;
a wavelength-specific signal level detecting process for detecting the power levels of the optical signals of the respective channels based on the analysis result obtained by the spectrum analyzing process;
an optical signal detecting process for deciding whether or not the power level of the optical signal detected by the wavelength-specific signal level detecting process with respect to each wavelength is lower than the lowest level of an received optical signal to detect optical signal input in each channel; and
a switching process for receiving the optical signals of the respective channels demultiplexed by the demultiplexer, and preventing the optical signal of the channel where no optical signal input has been detected by the optical signal detecting process from being input in the multiplexer.

38. An optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform:
a spectrum analyzing process for analyzing the spectrum of the multiplexed optical signal before being demultiplexed by the demultiplexer;
a wavelength-specific signal level detecting process for detecting the power levels of the optical signals of the respective channels based on the analysis result obtained by the spectrum analyzing process;
an optical signal detecting process for deciding whether or not the power level of the optical signal detected by the wavelength-specific signal level detecting process with respect to each wavelength is lower than the lowest level of an received optical signal to detect optical signal input in each channel; and
a signal level adjusting process for adjusting the signal level so as to attenuate the level of the optical signal of the channel where no optical signal input has been detected by the optical signal detecting process to the greatest extent possible before inputting the optical signal in the multiplexer.

39. An optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform:
a supervisory signal receiving process for receiving a supervisory signal indicating whether there is transmission of at least part of the optical signals of the respective channels which form the multiplexed optical signal input to the demultiplexer; and
a switching process for preventing the optical signal of each channel from being input in the multiplexer when it has been determined that no optical signal was transmitted to the channel by the supervisory signal receiving process.

40. An optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform:
a supervisory signal receiving process for receiving a supervisory signal indicating whether there is transmission of at least part of the optical signals of the respective channels which form the multiplexed optical signal input to the demultiplexer; and
a signal level adjusting process for adjusting the signal level so as to attenuate the level of the optical signal of each channel to the greatest extent possible when it has been determined that no optical signal was transmitted to the channel by the supervisory signal receiving process.

41. An optical power control program for controlling a computer of an intermediary device comprising a demultiplexer which receives a multiplexed optical signal obtained by multiplexing optical signals having different wavelengths, one channel being allocated for each, to demultiplex the multiplexed optical signal, and a multiplexer which receives the optical signals of the respective channels demultiplexed by the demultiplexer to multiplex the optical signals after their power levels have been adjusted, respectively, to perform:
a demultiplexed signal level detecting process for detecting the power levels of the optical signals of the respective channels demultiplexed by the demultiplexer;
an optical signal detecting process for deciding whether or not the power level of each optical signal detected by the demultiplexed signal level detecting process is lower than the lowest level of an received optical signal to detect optical signal input with respect to each channel;
a signal level adjusting process for adjusting the signal level so as to attenuate the level of the optical signal of the channel where no optical signal input has been detected by the optical signal detecting process to the greatest extent possible;
an adjusted optical signal detecting process for detecting optical signals which were adjusted by the signal level adjusting process; and
a signal level adjustment failure finding process for determining that a failure has occurred in the adjustment by the signal level adjusting process when no optical signal has been detected by the adjusted optical signal detecting process after optical signal input was detected by the optical signal detecting process.
